(19) United States
(12) Patent Application Publication
(10) Pub. No.: US 2020/0388163 A1
(43) Pub. Date: Dec. 10, 2020

(54) PREDICTION BASED CLIENT CONTROL

(71) Applicant: Telefonaktiebolaget LM Ericsson (publ), Stockholm (SE)

(72) Inventors: Congchi ZHANG, AACHEN (DE); Guido HIERTZ, AACHEN (DE); Yungpeng ZANG, WÜRSELEN (DE)

(21) Appl. No.: 16/463,945

(22) PCT Filed: Nov. 28, 2016
(86) PCT No.: PCT/EP2016/079045

§ 371 Date: May 24, 2019

(51) Int. Cl. G08G 1/00; G08G 1/01

(52) U.S. Cl. CPC G08G 1/22; G08G 1/0112; B60W 60/001; G08G 1/0145; G08G 1/0141

(57) ABSTRACT

A method, apparatus and computer program for controlling a client is disclosed comprising in receiving first information of at least one first client, wherein the first information allows to determine a position of the at least one first client at a time point T; predicting a traffic situation at the time point T using the first information; determining a change of at least one control parameter of a second client based on the predicted traffic situation at the time point T; and changing the at least one control parameter of the second client based on the determination result.

### TECHNICAL FIELD

Various embodiments relate to methods, apparatuses, computer program products and systems for controlling a client in a network, for example in scenarios where automated/autonomous vehicles are involved.

### BACKGROUND

By evolving from human-driven vehicles to automated/autonomous vehicles the industry, for example the automotive industry, is undergoing a revolutionary technical shift. Automated and autonomous vehicles will improve the safety of road transportation systems by correcting and avoiding human mistakes.

Adaptive Cruise Control (ACC) has already been commercially deployed in Advanced Driver Assistance System (ADAS) products. The goal of ACC is to achieve the same speed as a preceding vehicle and to keep the desired inter-vehicle gap at the same time. Maneuver decisions in ACC can be regarded as correction to the speed difference compared to a preceding vehicle and the difference between actual inter-vehicle gap and the desired value.

Recently, Cooperative Adaptive Cruise Control (CACC) was proposed to further improve system performance. With the help of vehicle-to-vehicle (V2V) communication a host vehicle can be aware of preceding vehicle's status, such as the current speed and acceleration.

In a cruise control method the desired distance towards a preceding vehicle is supposed to be proportional to the current speed. For example the distance can be evaluated as shown in the following equation:

S_{desired}=t_{g}·v+Sₘᵢₙ

In this equation t_{g} denotes the time gap, v denotes the current speed, and Sₘᵢₙ denotes the minimum acceptable distance between the vehicle and the preceding vehicle. In a stable traffic system disturbances would not be propagated upstream or amplified within the traffic flow. A stability level indicates the system capability of resolving disturbances introduced to the system. In general, a minimum time gap is required to keep system stable and a larger time gap leads to higher system stability. However, the traffic throughput (the number of vehicles passing by in a time unit) decreases when increasing the time gap value.

The required value of time gap for ACC systems is usually in the range of 1.1 seconds to 2.2 seconds. A CACC system is able to reach a comparable system stability level as the ACC system but with a smaller time gap value (between 0.6 seconds and 1.1 seconds). Comparatively, the CACC system can achieve higher traffic throughput than the ACC system.

The concept of platooning enables vehicles to move with extremely small gap between vehicles. Vehicles following the platoon leader receive steering commands directly from the leader and behave in the same way as the platoon leader. Studies on vehicle platooning have shown that the air drag can be reduced if trucks move with a small gap between them (for example 1.2 meter). Thus, maintaining a small inter-vehicle gap helps reducing fuel consumption.

Existing ACC and CACC systems can be regarded as an error feedback loop eliminating speed and inter-vehicle gap errors, however they cannot provide optimal maneuver decisions in order to minimize the inter-vehicle gap to for example 1.2 meter. The mechanisms of ACC/CACC systems suffer from stability and require a certain level of time gap (and so inter-vehicle distance) to keep the system stable. Thus, neither ACC, nor CACC are able to achieve an optimum traffic throughput and optimum fuel consumption.

Although the inter-vehicle gap can be smaller if vehicles move as one platoon and behave with high cohesion, it can't be optimum for stability reasons. Further flexibility is lost at individual vehicle level in the platoon. An individual vehicle in the platoon can no longer take individual decisions and only mimics the platoon leader's behavior. This makes leaving or joining a platoon complicated and needs system level coordination.

Moreover, the overall system latency of ACC and CACC systems, e.g. communication and processing delay and/or mechanical delays required to implement adaptations, leads to the issue that upcoming maneuver decisions are based on outdated information collected in the past. This makes maneuver decisions sub-optimal and may lead to hazardous situations, especially when following vehicles in a platoon take the same steering action as the platoon leader but with a time delay.

### SUMMARY

Therefore a need exists to improve existing systems (for example ACC and CACC) to mitigate the above mentioned problems in order to optimize traffic throughput and fuel consumption.

This need is met by the features of the independent claims, where a client may be a vehicle. The dependent claims define refinements and embodiments.

According to an aspect a method for controlling a client is provided. The method comprising receiving first information of at least one first client, wherein the first information allows to determine a position of the at least one first client at a time point T. The method further comprising predicting a traffic situation at the time point T using the first information, determining a change of at least one control parameter of a second client based on the predicted traffic situation at the time point T, and changing the at least one control parameter of the second client based on the determination result.

According to another aspect an apparatus for controlling a client is provided. The apparatus comprising a first module configured to receive first information of at least one first client, wherein the first information allows to determine a position of the at least one first client at a time point T. The apparatus further comprising a second module configured to predict a traffic situation at the time point T using the first information, a third module configured to determine a change of at least one control parameter of a second client based on the predicted traffic situation at the time point T, and a fourth module configured to change the at least one control parameter of the second client based on the determination result.

According to a further aspect another apparatus for controlling a client is provided. The another apparatus comprising at least one processor. The at least one processor may comprise a memory, the memory containing a program comprising instructions executable by the at least one processor. The at least one processor is configured to receive first information of at least one first client, wherein the first information allows to determine a position of the at least one first client at a time point T. The at least one processor is further configured to predict a traffic situation at the time point T using the first information; to determine a change of at least one control parameter of a second client based on the predicted traffic situation at the time point T, and to change the at least one control parameter of the second client based on the determination result.

According to another aspect a computer program is provided. The computer program comprising program code to be executed by at least one processor of an apparatus, wherein the execution of the program code causes the at least one processor to execute a method for controlling a client. The method comprising receiving first information of at least one first client, wherein the first information allows to determine a position of the at least one first client at a time point T. The method further comprising predicting a traffic situation at the time point T using the first information, determining a change of at least one control parameter of a second client based on the predicted traffic situation at the time point T, and changing the at least one control parameter of the second client based on the determination result.

According to a further aspect a method for controlling a client is provided. The method comprising collecting first information of the client at time point T−p and generating second information based on the first information, wherein the second information allows to determine a position of the client at time point T. The method further comprising transmitting the second information to a controlling entity, receiving at least one changed first control parameter from the controlling entity, determining a change of at least one second control parameter based on the changed at least one first control parameter, and implementing the changed at least one second control parameter at the client at a time point T or at a time point T minus an adaptation delay D_{adap}.

According to a further aspect a client is provided. The client comprising a first module configured to collect first information of the client at time point T−p and a second module configured to generate second information based on the first information, wherein the second information allows to determine a position of the client at time point T. The client further comprising a third module configured to transmit the second information to a controlling entity, a fourth module configured to receive at least one changed first control parameter from the controlling entity, a fifth module configured to determine a change of at least one second control parameter based on the changed at least one first control parameter, and a sixth module configured to implement the changed at least one second control parameter at the client at a time point T or at a time point T minus an adaptation delay D_{adap}.

According to a further aspect another client is provided. The another client comprising at least one processor. The at least one processor may comprise a memory, the memory containing a program comprising instructions executable by the at least one processor. The at least one processor is configured to collect first information of the client at time point T−p and to generate second information based on the first information, wherein the second information allows to determine a position of the client at time point T. The at least one processor is further configured to transmit the second information to a controlling entity, to receive at least one changed first control parameter from the controlling entity, to determine a change of at least one second control parameter based on the changed at least one first control parameter, and to implement the changed at least one second control parameter at the client at a time point T or at a time point T minus an adaptation delay D_{adap}.

According to another aspect a computer program is provided. The computer program comprising program code to be executed by at least one processor of an apparatus, wherein the execution of the program code causes the at least one processor to execute a method for controlling a client. The method comprising collecting first information of the client at time point T−p and generating second information based on the first information, wherein the second information allows to determine a position of the client at time point T. The method further comprising transmitting the second information to a controlling entity, receiving at least one changed first control parameter from the controlling entity, determining a change of at least one second control parameter based on the changed at least one first control parameter, and implementing the changed at least one second control parameter at the client at a time point T or at a time point T minus an adaptation delay D_{adap}.

According to a further aspect a system for controlling a client is provided. The system comprising at least one first client and an apparatus according to one of the previous aspects.

According to a further aspect another system for controlling a client is provided. The system comprising a client according to one of the previous aspects and an apparatus according to one of the previous aspects.

In contrast to ACC and CACC the described solution allows clients (for example vehicles) to move with minimized inter-client (vehicle) gaps while working in a stable system operating point. In other words, under the constraint of system stability, improved traffic throughput and reduced fuel consumption (due to minimized air drag) can be reached simultaneously.

Maneuver decisions are done based on the predicted “up-to-date” traffic situations and avoid the instability problem and danger situations that are attributed to the outdated information or knowledge used in the conventional ACC and CACC control methods.

Vehicle maneuver decision can be made individually for each vehicle based on the respectively predicted traffic situation. Vehicles can move together with high cohesion equivalent to a platooning system, if information is received from at least some surrounding vehicles and/or the environment. Flexibility of an individual vehicle to react to its respective traffic situation is kept, which avoids complex merging and splitting mechanisms like for example in platooning systems.

Superior performance compared to conventional ACC and C-ACC is provided, as far as multiple autonomous vehicles drive next to each other. Hybrid traffic situation, where both autonomous and non-autonomous vehicles present, can also benefit from the described solution, although the advantage is maximized in a homogenous autonomous vehicle environment.

Summarizing, the aspects as mentioned above enable an optimization of traffic throughput, and of fuel/energy consumption of clients (for example vehicles). The design of a more stable system is enabled, where the more stable system allows for example to optimize (reduce) the gap between clients (for example vehicles in a platoon). Still further the negative effect of communication latency between clients and/or clients and one or more network entity is mitigated.

It is to be understood that the features mentioned above, and the features yet to be explained below, can be used not only in the respective combinations indicated, but also in other combinations or in isolation, without departing from the scope of the present invention. Features of the above-mentioned aspects and embodiments may be combined with each other in other embodiments.

### BRIEF DESCRIPTION OF THE DRAWINGS

The foregoing and additional features and effects of the invention will become apparent from the following detailed description when read in conjunction with the accompanying drawings showing example embodiments. The elements and steps shown in the figures are illustrating various embodiments and show also optional elements and steps.

FIG. 1 shows an example embodiment of a decentralized system comprising vehicles as clients from the perspective of vehicle 1-2.

FIG. 2 illustrates an example of a centralized system comprising a central network entity and vehicles as clients from the perspective of vehicle 1-2.

FIG. 3 shows an example embodiment of a message flow diagram for the decentralized approach shown in FIG. 1.

FIG. 4 illustrates an example embodiment of a message flow diagram for the centralized approach shown in FIG. 2.

FIG. 5A illustrates timing diagrams of two example embodiment of the decentralized approach.

FIG. 5B illustrates timing diagrams of two example embodiment of the centralized approach.

FIG. 6 shows an example embodiment of a method for the decentralized approach.

FIG. 7 shows an example embodiment of a method for the centralized approach

FIG. 8 shows an example embodiment of a client.

FIG. 9 shows an example embodiment of a network entity.

FIG. 10 shows another example embodiment of a client or a network entity.

FIG. 11 shows an example embodiment of a method for a client in the centralized approach

FIG. 12 shows an example embodiment of a client in the centralized approach.

### DETAILED DESCRIPTION

In the following description, for purposes of explanation and not limitation, specific details are set forth, such as for example particular network environments embodiments with respect to autonomous vehicles, in order to provide a thorough understanding of the invention. It will be apparent to one skilled in the art that the invention may be practiced in other embodiments that depart from these specific details. For example, the skilled person in the art will appreciate that the current invention may be practised with any wireless network like for example UMTS (Universal Mobile Telecommunications System), GSM (Global System for Mobile Communications), LTE (Long Term Evolution) or 5G (5^{th} Generation Mobile Network supporting for example machine-to-machine type communication) networks. As another example, the invention may also be implemented in short-range wireless networks such as WLAN (Wireless Local Area Network), Bluetooth, WiFi (synonym to WLAN) or V2X (Vehicle to anything) systems.

Embodiments will be described in detail with reference to the accompanying drawings. The scope of the invention is not intended to be limited by the embodiments described hereinafter or by the drawings, which are taken to be illustrative only. Elements or steps shown in the drawings may be optional and/or their order may be exchangeable.

The drawings are to be regarded as being example schematic representations, flow diagrams and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings, or described herein, may also be implemented by an indirect connection or coupling. A coupling between components may also be established over any wireless connection. Functional blocks may be implemented in hardware (HW), firmware, software (SW), or a combination thereof.

In the following description detailed example embodiments are described with respect to a traffic scenarios on a road where a client is typically a vehicle. However this shall be not interpreted as limiting. The described methods and entities or clients can be used in any scenario where a prediction of traffic situations can be applicable. For example a client could be also a pedestrian moving around and being warned via his mobile device about an upcoming danger situations, or a client could be a traffic light or an adjustable speed limit sign which is controlled based on the a predicted traffic situation or provides information used as input for controlling another client (vehicle). Further traffic scenarios are not limited to roads or streets, they can also relate to any other traffic like for example to train or air traffic, or traffic in the outer space.

A client may be a vehicle (like for example a car, a truck, a bike, a motorbike, a plane, a drone, a boat, a submarine, . . . ) or any self-driving entity (like for example a robot), a mobile device (like for example a smart phone, a tablet, a laptop . . . , which may be located inside a vehicle or may be carried by a pedestrian), or an infrastructure element (like for example a traffic sign, a traffic light or a road side cabinet). A client may be further a module comprising at least partly functionality related to vehicle, mobile device or an infrastructure element. The client may be integrated into a vehicle or being part of a vehicle. The vehicle may be an autonomous vehicle.

An autonomous vehicle can be any vehicle supporting autonomous or partly autonomous driving and which can communicate with other vehicles and/or infrastructure devices in its surrounding. Partly autonomous driving may relate for example to ACC or CACC.

Vehicle to vehicle (V2V) and/or vehicle to anything (V2X) communication may be done via a dedicated link (for example a “side link”), cellular network connections, WLAN, WiFi or any other wireless access technology. Vehicles may also relay information between each other in order to establish a connection between two vehicles where a direct (for example wireless) connection would not be possible.

A network entity may be a server (for example an application server for example located at a traffic management center of a road authority), an entity located close to a client (for example located in a road side cabinet or in a base station site), or may be integrated inside a telecommunication node in the core or access network (for example integrated into a base station serving a certain area). The network entity may be part of a “special” client, like for example the leader of a platoon or a coordinator for a group of clients. The network entity can be a central controller performing the claimed functionality (for example receiving information from client, predicting a traffic situation at time point T, changing client specific control parameters based on the predicted traffic situation, informing the client(s) about the changed control parameters).

A perception area may be an area around one or more clients, wherein events in the perception area may have influence on the behaviour of the clients. The perception area may be for example limited to an area where a client can communicate directly with other clients, a defined area, or a fixed area around a client wherein the fixed area moves together with the client. The shape of the perception area may be 2- or 3-dimensional and may be for example a square, a rectangle, a circle, an oval, a cube or any kind of sphere.

A sensor of a client may be any kind of sensor related to a client. The sensor may detect environmental parameters (for example temperature, weather conditions, light conditions, . . . ), characteristics of the client (for example speed, driving direction, acceleration, . . . ) or characteristics of other clients (for example via monitoring clients in the surrounding of the client via radar or some other means).

A control parameter may be any kind of parameter controlling (at least partly) a functionality of a client. Control parameters may be parameters related to speed (acceleration, deceleration) and/or parameters influencing the heading (driving) direction of the client. However, also other control parameters may be meant (for example if the client is a vehicle control parameters may control the functionality of the vehicle lights, windscreen wipers or warning means).

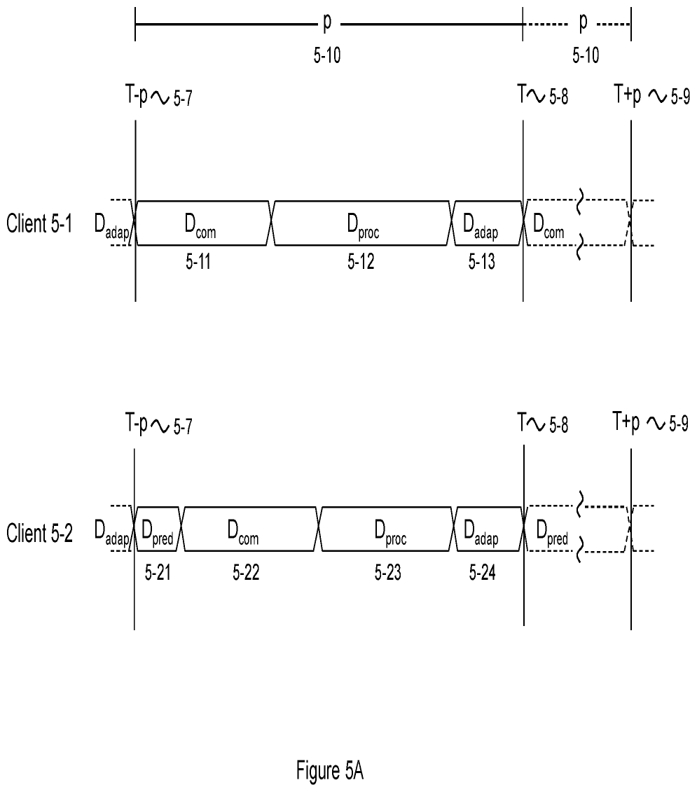

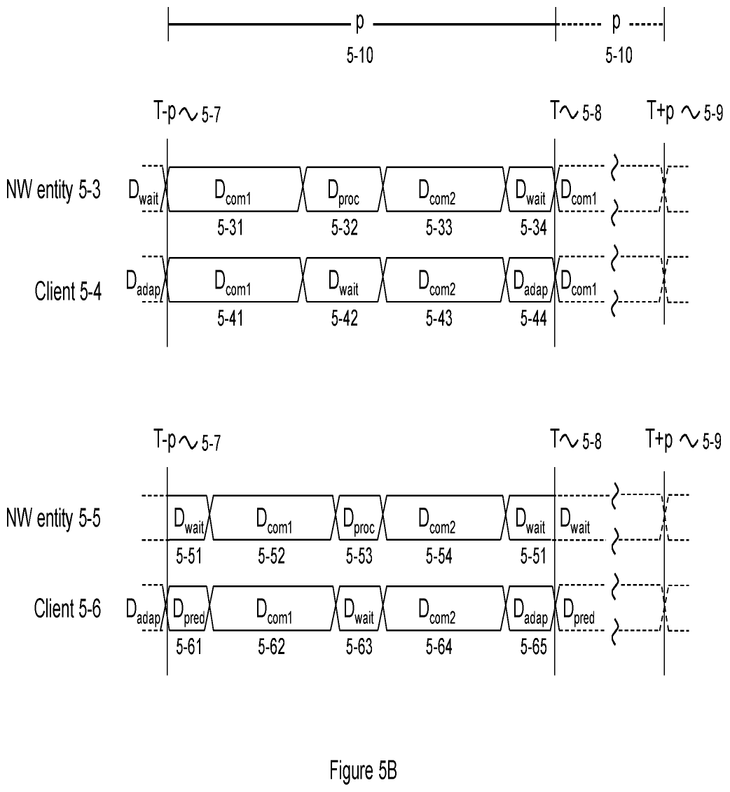

Status information of a client may relate to the speed of a client, the direction where the client is heading, a position of the client, acceleration or deceleration of the client, environmental data collected by the client, or a maneuver decision used by the client. The status information may relate to a specific time point (for example time point T−p (5-7) as shown in FIGS. 5A and 5B). In general, status information may be any information collected and/or detected by the client at a defined time point.

A traffic situation may reflect a traffic situation at a defined time point (for example time point T). The traffic situation may comprise position information of one or more clients (for example vehicles) at time point T, speed and/or heading direction of the client(s) (or any other parameter related to the clients), surrounding conditions (for example weather or road conditions), traffic light status, adaptable traffic sign status (for example variable speed limit signs), or any other parameter which may have influence on how a vehicle (that may be part of the traffic situation) will behave in the future. A traffic situation may be limited to a perception area.

A wireless communication may be any kind of wireless communication like for example WLAN, WiFi, cellular access (like for example GSM, UMTS, LTE, 5G) or a side link.

Environmental information may be environmental data collected via local sensor or received from remote devices (like for example other clients like vehicles, street sensors, road side cabinets, traffic lights, variable traffic lights, or other network elements providing related information). Environmental data may relate to road conditions, weather conditions, traffic conditions (for example traffic density, speed, danger situation information, . . . ), status and future behaviour of traffic lights, variable traffic sign status or any other kind of information which could be taken into account when making for example vehicle maneuver decisions for a client.

An maneuver rule can be any rule which can be used for calculating client control parameters (for example ACC and CACC are maneuver rules for autonomous vehicles)

Synchronized to a common time base means that the involved clients and/or the involved network entity or entities are synchronized to a common time source and perform their actions in a synchronized manner. For example the changing of the at least one control parameter in the involved clients may be performed in a synchronous manner at the same time point T. Also other claimed steps may be performed in a synchronized manner in different clients or entities. The time base may be an external synchronization source (for example located in a telecom network) or may be an external source like for example GPS (Global Positioning System) or GNSS (Global Navigation Satellite System).

Due to the existence of communication and processing delays, a client (for example vehicle) control system may use information which was collected in the past (for example at time point T−p) by sensors from clients and infrastructure elements sharing this information via for example wireless communication means. This information can be used by the control system to make maneuver decisions for the clients, which will be communicated and then mechanically executed by the clients at time point T. Compared with the actual traffic situation at time T (for example actual location, speed, acceleration of a client) the information acquired at time point T−p is considered outdated for making the decision executed at time point T. The proposed solution solves (or at least mitigates) this problem.

A time synchronized system is proposed, which collects information at time T−p. The collected information may comprise the knowledge of client specific maneuver rules. In general it is proposed to predict the traffic situation in the vicinity of a client at the future time point T. Using the predicted traffic situation at time point T, optionally together with up-to-date information from the local sensors of the client (if available), the control system is able to make the optimal maneuver decision for that client at time point T enabling a higher level of coordination among clients and an improved traffic efficiency.

The described solution enables to make maneuver decision for clients using a predicted (road) traffic situation based on previously collected information from other clients and information about the environment. The solution can aim for example at reaching the desired distance at a client vehicle towards the preceding client vehicle at the end of the next time interval p. Two non-limiting embodiments will be described using a centralized and a distributed system architecture, respectively. Both embodiments describe a time synchronized system where enabled clients periodically update their maneuver decision in a synchronized manner.

In the centralized system architecture a control system for the clients is implemented at a central network entity, for example at a remote vehicle control center. There may be several central network entities serving for example clients located in different sub-areas. For the distributed system architecture the control system is distributed among the clients, for example each client may perform control decisions for itself by taking input from other clients and/or the environment into account. In both cases the clients are synchronized to a common time base.

The following example embodiments will be described with vehicles as an example for a client, however this shall be not interpreted as limiting.

In both systems (centralized or distributed) a control system may determine maneuver decision for a vehicle in order to for example reach the desired distance between the vehicle and its preceding vehicle after the next time interval. For instance, if the current gap between two neighboring vehicles is larger than the desired value, with the awareness of the preceding vehicle's intention, the following vehicle would adjust its acceleration to an appropriate value, under the constraint of maximum acceleration ability, so that the desired inter-vehicle gap can be achieved after the following vehicle moving according to the new acceleration in the next time interval. With the help of traffic situation prediction, the upcoming maneuver decision at each vehicle fits the predicted road traffic situation when upcoming maneuver decision will be conducted. In this way, the vehicle control system is able to keep the minimum inter-vehicle gap and system stability at the same time, if the control system of each vehicle can receive the information from other vehicles. In other words, this control method could be the optimal choice in terms of optimizing traffic throughput under the constraint of system stability.

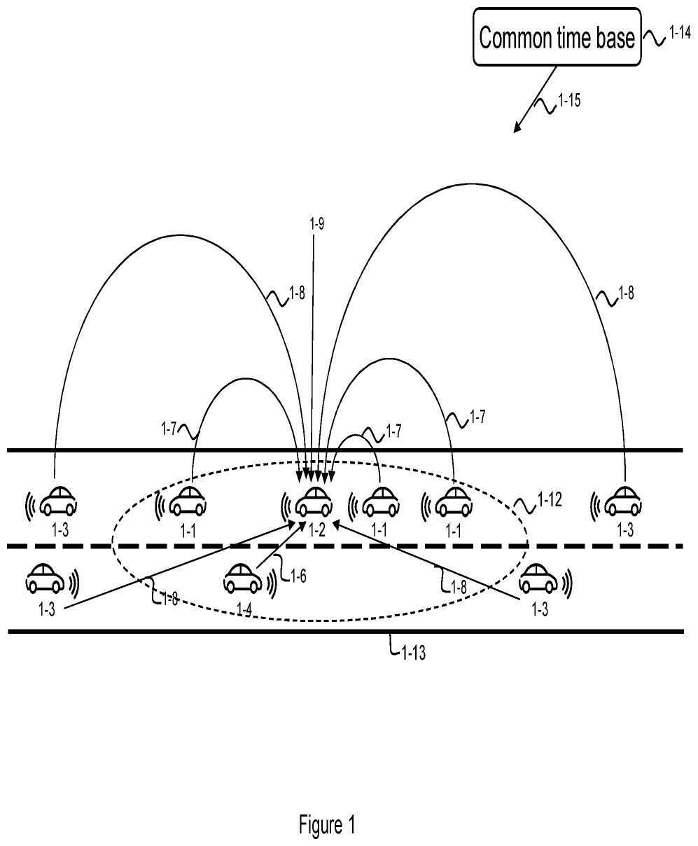

FIG. 1 show an example of a distributed system architecture where the control system is implemented in autonomous vehicles. Autonomous vehicles 1-1, 1-2, 1-3 and 1-4 are driving on highway 1-13. Maneuver decisions are done for each vehicle by the control system implemented at the corresponding vehicle. The control system of each vehicle may use wireless communication means to exchange information with the environment and surrounding vehicles. Information about vehicles not being able to communicate with each other (for example legacy vehicles not supporting autonomous driving—not shown in FIG. 1) may be determined by the control system of an autonomous vehicle by monitoring its surrounding, for example by utilizing a radar to detect legacy vehicles and related properties (like for example speed, driving direction etc. . . . of the legacy vehicle). Collected information about legacy vehicles may be exchanged between autonomous vehicles. This enables autonomous vehicles not being able to detect legacy vehicles, or where the legacy vehicle is not in the detection range, to consider also the collected information about legacy vehicles received from other autonomous vehicles when making their maneuver decisions.

The example of FIG. 1 illustrates the distributed system from the perspective of autonomous vehicle 1-2 and its control system (legacy vehicles and information transmitted to vehicles 1-1, 1-3 and 1-4 is not shown). The autonomous vehicles 1-1, 1-2, 1-3 and 1-4 are synchronized to a common time base 1-14 which provides synchronization 1-15 to the vehicles. Vehicles 1-1, 1-3 and 1-4 collect local information (for example dynamic information like location, current speed, heading direction, acceleration rate, local maneuver rule, distance to preceding vehicle, etc.) at time point T−p. The information may be collected from local sensors. The information collected at time point T−p may broadcast (or send on request, 1-6, 1-7, 1-8), optionally together with the information about the maneuver rule that a vehicle is using, to surrounding vehicles using wireless communication (only shown towards vehicle 1-2 in FIG. 1). Each vehicle receives information broadcasted by other vehicles in the vicinity.

As shown in FIG. 1 vehicle 1-2 may receive information 1-6, 1-7 and 1-8 collected at T−p from surrounding vehicles 1-1, 1-3 and 1-4. In addition vehicle 1-2 may receive 1-9 information about the environment (for example weather and road condition information or information from infrastructure elements in its vicinity like for example traffic lights or variable traffic signs, not shown in FIG. 1). Vehicle 1-2 may either receive the information either periodically via broadcast messages, or may request the information (for example via individual or group request). The information may be requested once for a certain time period and with a certain frequency, thus avoiding to send frequent requests within the time period to the same vehicle/client.

Before retrieving (for example by requesting) and processing information from the surrounding vehicles and/or the environment, vehicle 1-2 may determine its perception area 1-12, which may be limited by its effective communication range and computation capabilities. Alternatively the perception range may be fixed defined (for example as a circle with a fixed diameter). Information from vehicles or other clients (for example infrastructure elements like traffic lights or traffic signs) outside the perception range 1-12 may be ignored by vehicle 1-2 in order to limit the processing effort to the area (for example the perception area) where a traffic prediction is useful for the vehicle 1-2. In order to optimize the prediction process vehicle 1-2 may also exclude vehicles within the perception area if they would have no influence on maneuver decisions for vehicle 1-2 (for example vehicle 1-5 driving on the opposite side of the highway may be excluded, thus the information 1-6 received from vehicle 1-4 may be ignored). The determination of the perception area is optional and may not be needed if the area is for example automatically limited by the effective wireless communication range of for example vehicle 1-2. If the perception range exceeds the effective wireless communication range, communication with clients (vehicles) outside the communication range may be achieved by relaying the information and/or requests, for example by another client (vehicle) or wireless infrastructure elements (for example a based station).

In the example of FIG. 1 vehicle 1-2 receives information from vehicles 1-1 (information 1-8), vehicles 1-3 (information 1-8) and vehicle 1-4 (information 1-6). Vehicles 1-3 are outside the perception area 1-12 and therefore information 1-8 received by vehicle 1-2 may be ignore. In addition vehicle 1-2 may ignore information 1-6 from vehicle 1-4 located inside the perception area 1-12, since vehicle 1-4 is driving on the opposite side of the highway in the opposite direction and may not have any influence on the maneuver decisions (control) of vehicle 1-2.

Then vehicle 1-2 predicts the traffic situation at time point T (for example the position, speed, acceleration rate of surrounding vehicles 1-1 in its perception area 1-12, optionally predicting also the maneuver decisions of vehicles 1-1 at time T). This may be done by assuming that the identical vehicle maneuver rule is used at all vehicles, e.g. a desired distance oriented vehicle maneuver rule. Alternatively the vehicle maneuver rule may be received (1-7) from surrounding vehicles per wireless communication. T is the time point in the future where the next maneuver decision will be executed synchronously by the vehicles. In order to predict the maneuver decisions at its surrounding (for example preceding) vehicles at the future time T, the control system at vehicle 1-2 may perform the prediction one vehicle by one vehicle, preferably starting from the most distant preceding vehicle in its perception range 1-12.

Alternatively vehicles 1-1 may predict their position and properties at time point T by themselves after executing their maneuver decision at time point T−p, and send/broadcast the predicted information (1-7) to vehicle 1-2. This saves computation resources at vehicle 1-2, since vehicle 1-2 does not need to perform the prediction for each vehicle by itself, instead it could simply combine the received information 1-7 in order to predict the traffic situation in its surrounding at time point T.

After the traffic situation at time T has been predicted, vehicle 1-2 determines its own maneuver decision based on the predicted (road) traffic situation, optionally taking up-to-date local sensor information (e.g. current position and speed of vehicle 1-2) and available information about the environment 1-9 into account. Information about the environment may be temperature, road conditions, other weather conditions, traffic light status, variable traffic sign status, etc. . . . , which may be detected via local sensors or received 1-9 from road side cabinets, traffic lights, variable traffic signs or other network elements).

At time T vehicle 1-2 executes, together with the other autonomous vehicles, the determined maneuver decisions in a synchronized manner (for example simultaneously). After this the process is repeated with the next execution point being at time point T+p.

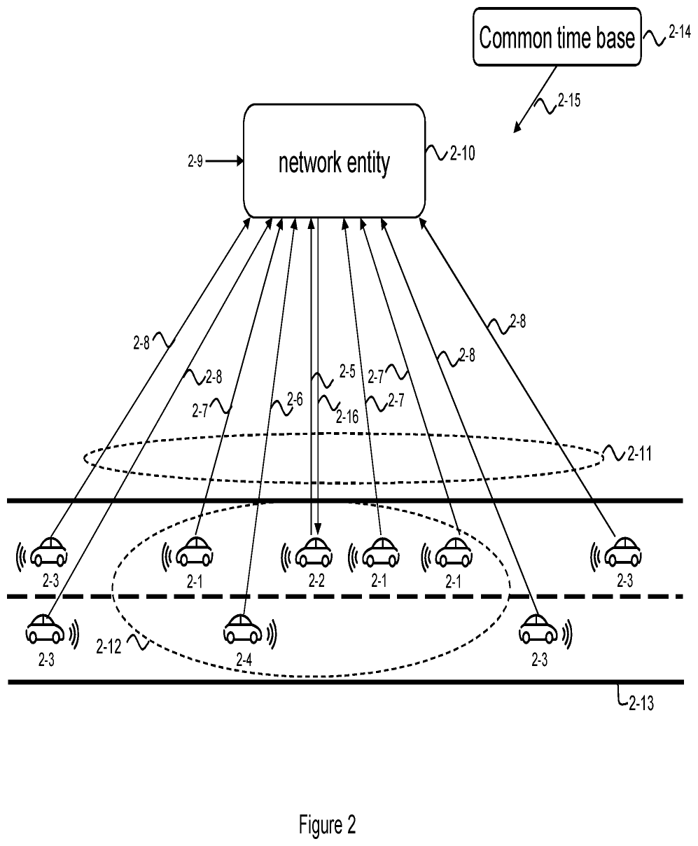

FIG. 2 shows an example embodiment for a centralized control system implemented in a network entity 2-10. The network entity 2-10 may be for example an application server or may be an entity located close to the clients (vehicles), for example comprised in a road side cabinet or co-located or integrated to a base station. There may be several network entities 2-10 implementing centralized control system functionality, for example for different geographical areas.

FIG. 2 shows a similar traffic scenario as FIG. 1 with a road 2-13 and autonomous vehicles 2-1, 2-2, 2-3 and 2-4. Like FIG. 1 also FIG. 2 shows the scenario from the perspective of vehicle 2-2 which is controlled by the network entity 2-10. The other vehicles 2-1, 2-3 and 2-4 may be controlled by the network entity 2-10 as well, however this is not shown in FIG. 2. Like the autonomous vehicles also network entity 2-10 is synchronized to a common time base 2-14 via synchronization 2-15.

Network entity 2-10 acts as a central controller and communicates with autonomous vehicles using for example wireless communication means 2-11. Network entity 2-10 controls (or at least influences) the movements of the vehicles by sending maneuver decision (2-16, shown here only for vehicle 2-2) to autonomous vehicles.

Like for FIG. 1 vehicles 2-1, 2-2, 2-3 and 2-4 collect local information at time point T−p. Each vehicle may broadcast (or send on request) the information (2-5, 2-6, 2-7, 2-8) collected at time point T−p to the network entity 2-10. Alternatively vehicles 2-1, 2-2, 2-3 and 2-4 may predict their position and properties at time point T by themselves after executing their maneuver decision at time point T−p, and send/broadcast the predicted information (2-5, 2-6, 2-7, 2-8) to network entity 2-10. This saves computation resources at network entity 2-10, since network entity 2-10 does not need to perform the prediction for each vehicle by itself, instead it could simply combine the received prediction information 2-5, 2-6, 2-7 and 2-8 in order to predict the traffic situation at time point T.

Compared to the content of information 1-6, 1-7 and 1-8 of FIG. 1, information 2-5, 2-6, 2-7 and 2-8 of FIG. 2 may comprise in addition information about the perception area 2-12 of each vehicle. Alternatively the perception area may be determined by the network entity 2-10 in a comparable manner as mentioned with respect to vehicle 1-2 of FIG. 1. Network entity 2-10 may utilize position data of each vehicle to determine the vehicle specific perception area, or may determine a perception area for a group of vehicles (for example co-located vehicles) or may apply one or more fixed defined perception areas.

Network entity 2-10 may collect in addition environmental information 2-9 (comparable to the environmental information 1-9 collected by vehicle 1-2 in FIG. 1).

The network entity 2-10 receive the information 2-5, 2-6, 2-7 and 2-8 from the vehicles and predicts the traffic situation at time point T. T is the time in the future where the next vehicle maneuver decision will be executed by the vehicles.

Then network entity 2-10 determines maneuver decision at time point T for each vehicle based on the predicted traffic situation at time point T following a specific maneuver rule, for example a desired distance oriented vehicle maneuver rule like ACC or CACC. In order to optimize the computation effort (and so for example minimizing computational delay) network entity 2-10 may limit the traffic situation prediction for each vehicle to the perception area of the vehicle or to even a smaller area.

Preceding vehicle's maneuver decision may be determined first, so that following vehicle's maneuver decision can take the preceding vehicle's decision into account. Optionally the network entity 2-10 may take also environmental data 1-9 into account when determining the maneuver decisions.

When maneuver decisions are determined, the controller (network entity 2-10) sends the maneuver decisions to the corresponding vehicles (for example maneuver decision 2-16 for vehicle 2-2). The maneuver decisions may be send as information of one or more control parameter(s) to be changed at time point T to each vehicle.

After receiving information about the maneuver decision (for example control parameter(s) to be changed) from the network entity 2-10 (for example 2-16 for vehicle 2-2), the vehicles may evaluate and, if necessary, amend the received maneuver decision/control parameter(s) based on up-to-date local sensor data, for example to prevent possible imminent dangerous situation that may occur due to the communication delay or to adapt the maneuver decision to local changes that occurred after the sending of the information to the network entity 2-10 was done (for example the sending of information 2-5 in case of vehicle 2-2).

The received vehicle specific maneuver decisions (for example changed control parameters 2-16 for vehicle 2-2) are then executed (implemented) at time point T at the vehicles in a synchronized manner (for example simultaneously). Executing means that decisions/changes are implemented by mechanically adapting, for example acceleration or deceleration of a vehicle, according to the decision. In order to compensate possible vehicle internal delay in the execution (also called adaptation delay), the actual implementation of the changed control parameter(s) may for example happen already before time point T at time point T minus the adaptation delay.

After executing the decision vehicles repeat the process and report information 2-5, 2-6, 2-7 and 2-8 to the network entity 2-10, however now related to time point T. The whole process will then repeat with a period of p.

For both scenarios (centralized and distributed system as shown in FIGS. 1 and 2), instead of broadcasting/sending each vehicle's current information at time point T−p (for example moving status and/or environment information at T−p), the vehicle may predict its status for time point T and broadcast/sent its predicted information at time point T directly. This will help other vehicles (for example vehicle 1-2) or the network entity 2-10 to conduct a traffic situation prediction and make the optimal maneuver decision. By sending the predicted data of a vehicle at time point T the receiving vehicle 1-2 or network entity 2-10 does not need to make the prediction for each vehicle anymore, it just needs to combine the received predicted information from the vehicles to determine the predicted traffic situation. This saves processing effort at the receiving vehicle 1-2 or the network entity 2-10, and can speed up the whole process due to a reduced processing time at the receiving vehicle 1-2 or network entity 2-10.

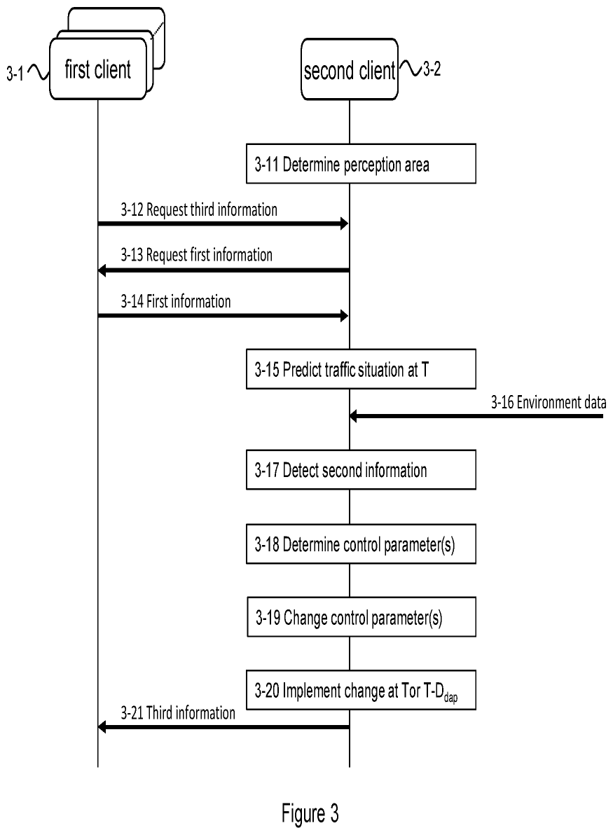

FIG. 3 shows an example message flow diagram for the distributed system scenario shown in FIG. 1, involving one or more first clients 3-1 and a second client 3-2, where the clients 3-1 and 3-2 may correspond to vehicles 1-1 and 1-2 of FIG. 1. The message flow diagram shows the process from the second client 3-2 perspective, where the second client 3-2 implements the control system for itself and where the control system acts based on input from the one or more first client(s) 3-1 received in step 3-14 and optionally on received and/or detected environment data in step 3-16.

In step 3-11 the second client 3-2 may determine its perception area (for example 1-12 in FIG. 1). Step 3-11 is optional and may be also performed at a later phase of the process, for example between step 3-14 and 3-15.

In optional step 3-12 the second client 3-2 may receive a request(s) from the first client(s) 3-1 for a third information. The requested third information may comprise information about the status of the second client 3-2 after the execution of the next maneuver rule (implementation of changed control parameter) at time point T which may be transmitted in step 3-21 after time point T by the second client 3-2. The status data of the second client 3-2 may comprise for example the speed, driving direction, acceleration or used maneuver rule of the second client 3-2 after time point T.

In optional step 3-13 second client 3-2 request first information from the at least one first client 3-1, wherein the requested first information may comprise information about the status of the one or more first clients 3-1 after the execution of the last maneuver rule (or implementation of changed control parameter) at time point T−p. The status data of the one or more first client 3-1 may comprise for example the speed, driving direction, acceleration or used maneuver rule of a first client 3-1 after time point T−p. The request in step 3-13 may be only send to first client(s) 3-1 in the perception range. Step 3-13 is optional since the first clients 3-1 may for example also broadcast the first information periodically (for example in a synchronized manner synchronized to the time based mentioned in conjunction with FIGS. 1 and 2), so that no request is necessary.

In step 3-14 the second client 3-2 receives the first information (either after requesting it or via broadcast) from one or more of the first clients 3-1. The first information reflects the status of client(s) 3-1 after or at time point T−p when the latest maneuver decision has been executed (control parameter change has been implemented) in client(s) 3-1. The first information may comprise the position of a client or status information which allows to determine the position of the client, for example at time point T.

In step 3-15 client 3-2 predicts the traffic situation status of its surrounding at time point T utilizing the received first information in step 3-14, optionally by taking the perception area determined in step 3-11 into account. The prediction may be done starting from the first client 3-1 which is furthest away from the second client 3-2, optionally also considering the position and heading direction of first client 3-1 (in order to identify if the first client 3-1 is driving ahead of the second client 3-2).

After the second client 3-2 has predicted the traffic situation at time point T, client 3-2 will determine in step 3-18 at least one control parameter of the second client 3-2 to be changed in order to react to the predicted traffic situation T. The determination of the at least one control parameter in step 3-18 may optionally take into account received environment data/information (optional step 3-16) and detected second information (step 3-17) comprising current local data from the second client 3-2 (for example current data detected from local sensor, like current speed, current heading direction, current position, current acceleration etc. . . . ). Environmental data may be for example status data from traffic lights—including future change indications of a traffic light, traffic sign data, road condition data or weather data.

Based on the result of the determination in step 3-18 the second client 3-2 changes the at least one control parameter in step 3-19. The change may relate to a specific maneuver rule used by the second client 3-2.

In step 3-20 the change of the at least control parameter may be implemented in the second client 3-2 at time point T (synchronized with other clients, for example the at least one first client 3-1). As mentioned more in detail in connection with FIG. 5A, the implementation of the change may be done before time point T to compensate a possible adaptation delay.

Finally in optional step 3-21 the second client 3-2 reports the third information to clients in its surrounding, which may be limited for example to the one or more first client(s) 3-1 in the determined perception area. As mentioned earlier this can be done in response to one or more requests received in optional step 3-12 or as broadcast or multicast transition performed after the change of the at least one control parameter has been implemented in step 3-20.

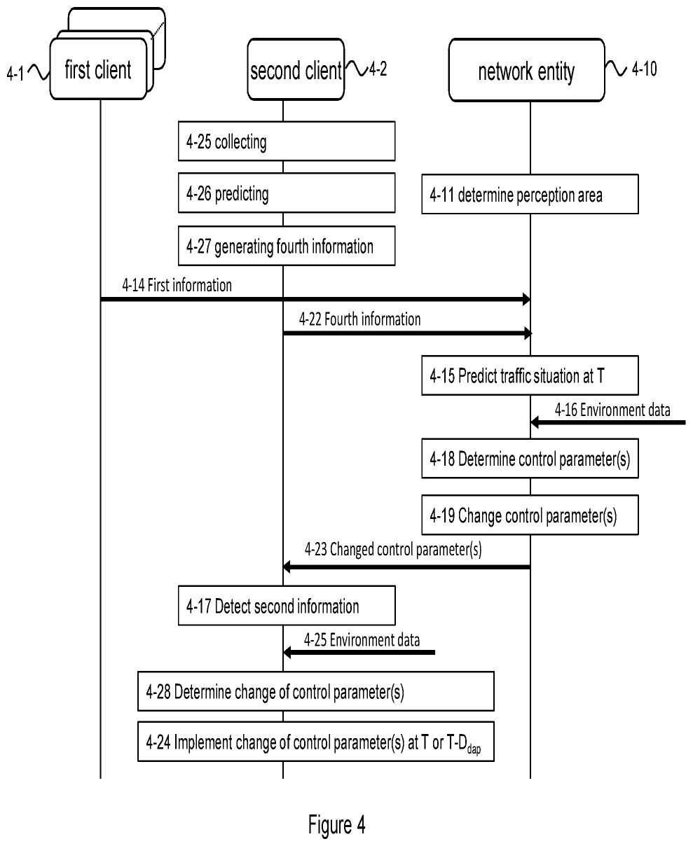

FIG. 4 illustrates an example message flow diagram for the centralized system scenario shown in FIG. 2 involving one or more first clients 4-1, a second client 4-2 and a network entity 4-10, where the clients 4-1 and 4-2 may correspond to vehicles 2-1 and 2-2 of FIG. 2, and the network entity 4-10 may correspond to the network entity 2-10 of FIG. 2. The message flow diagram shows the process from the second client 4-2 perspective, where the network entity 4-10 implements the control system for the clients (shown for client 4-2 only in FIG. 4). The control system (network entity 4-10) acts based on input from the one or more first client(s) 4-1 and the second client 4-2 (shown in steps 4-14 and 4-22) and on optionally received and/or detected environment data in step 4-16.

In the optional step 4-11 the network entity 4-10 may determine the perception area for each client, or alternatively for a group of clients which may be co-located or located close together. The perception area may be determined based on information received from the clients, thus step 4-11 may be also performed after step 4-22 in order to determine the perception area of for example client 4-2 based on the latest information received (4-22) from client 4-2. Alternatively the perception area may be determined by the client (not shown) and transmitted to the network entity 4-10 together with the information from the client (for example with the fourth information 4-22 received from client 4-2).

In optional step 4-25 the second client 4-2 may collect status information about itself (for example one or more of position, speed, acceleration or heading direction of the second client) at time point T−p. In optional step 4-26 the second client 4-2 may use the collected information to predict the status information of the second client 4-2 at time point T. In optional step 4-27 the second client 4-2 may generate fourth information which may be the information collected in step 4-25, or the information predicted in step 4-27 or a combination of both.

In steps 4-14 and 4-22 network entity 4-10 receives first and fourth information from one or more fist client 4-1 and the second client 4-2. The first information can be for example information 3-14 of FIG. 3 or information 2-7 of FIG. 1, where the first information may comprise information about the respective client at time point T−p or predicted information of the respective client at time point T. The first and fourth information may comprise status information comprising the position of the respective client or status information which allows to determine the position of the respective client, for example at time point T. The first and fourth information may additionally comprise details about the clients perception area or details about environmental data collected by the client.

In step 4-15 the network entity 4-10 predicts a traffic situation at time point T based on the information received in steps 4-14 and 4-22. The traffic situation may be specific for a certain client (for example from the perspective of client 2-2 or 4-2 as shown in FIGS. 2 and 4), or may be specific for a group of clients or for a certain area. The area may be for example the perception area determined in step 4.11 or received from the clients in steps 4-14 or 4-22). If the prediction is done from the perspective of a specific client like for example the second client 4-2 as shown here, the prediction may be done starting from the first client 4-1 which is furthest away from the second client 4-2, optionally also considering the position and heading direction of the first client 4-1 (in order to for example identify if the first client 4-1 is driving ahead of the second client 4-2).

After the network entity 4-10 has predicted the traffic situation at time point T (for example from the perspective of second client 4-2), the network entity 4-10 will determine in step 4-18 at least one control parameter of the second client 4-2 to be changed in order to react to the predicted traffic situation T. The determination of the at least one control parameter in step 4-18 may optionally take into account latest received environment data (optional step 4-16) by the network entity 4-10. Environment data may be for example status data from traffic lights—including future change indications of a traffic light, traffic sign data, road condition data or weather data.

Based on the result of the determination in step 4-18 the network entity 4-10 determines a change of the at least one control parameter in step 4-19. The change may relate to a specific maneuver rule used by the second client 4-2.

Finally the network entity 4-10 transmits the changed at least one control parameter in step 4-23 to the second client 4-2.

After receiving 4-23 information about the maneuver decision (for example the changed at least one control parameter) from the network entity 4-10, second client 4-2 may evaluate and, if necessary, may amend or change the received maneuver decision/control parameter(s) based on up-to-date detected second information 4-17 from the second client 4-2 (for example detected via local sensors) and/or based on received environment data 4-25 (for example data from traffic lights or traffic signs). This may be done to prevent possible imminent dangerous situation that may occur due to the communication and processing delay between steps 4-22 and 4-23. The amending or changing of the received maneuver rule/control parameter(s) is done in step 4-28 of FIG. 4.

The second client 4-2 will then implement the changed at least one control parameter (and so execute the new maneuver decision) at time point T in step 4-24. The implementation time point T is synchronized in the clients and happens at the same time. As described more in detail in connection with FIG. 5B, the implementation of the change may be done before time point T to compensate a possible adaptation delay.

After the implementation of the changed at least one control parameter in the second client 4-2 in step 4-24 the process starts all over again, the clients (4-1, 4-2) report new first and fourth information reflecting the status of the clients at time point T or predicted status for time point T+p, the network entity predicts the traffic situation at time point T, . . . .

In a similar manner as shown for the second client 4-2 above with respect to FIG. 4, the network entity 10 may also control (or at least influence) maneuver decisions of other clients, like for example the one or more first clients 4-1.

Turning now to FIGS. 5A and 5B. In the centralized and distributed architectures client (vehicles) are synchronized to a common time base. The vehicles periodically adapt their movements (for example acceleration) in a synchronized manner (for example at the same time) according to vehicle maneuver decision made by the control system (reflected for example in control parameter changes for a vehicle). Vehicles may maintain the same acceleration or deceleration within each time interval p. In general, the time interval p shall be large enough to accommodate the communication time D_{com} for the vehicle to exchange information with surrounding vehicles, infrastructures or the vehicle control center (central network entity, for example network entity 2-10 of FIG. 2, network entity 4-10 of FIG. 4, or network entity 5-3 or 5-5 of FIG. 5B), the processing time D_{proc} for the vehicle control system to determine vehicle maneuver decisions according to for example a specific vehicle maneuver rule, and the mechanical adaption time D_{adap} for the vehicle to execute the vehicle maneuver decision. The time interval p shall be small enough for real-time vehicle maneuvering, for example 10 ms.

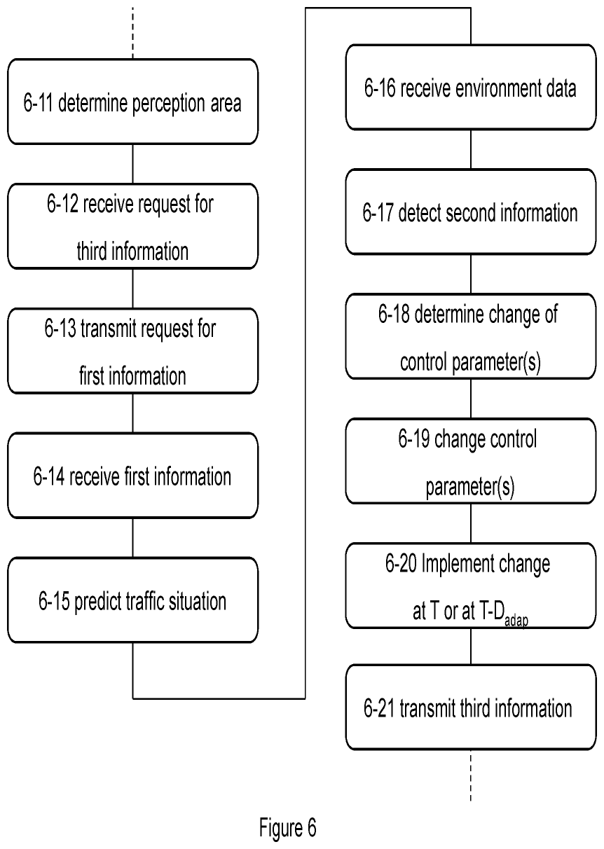

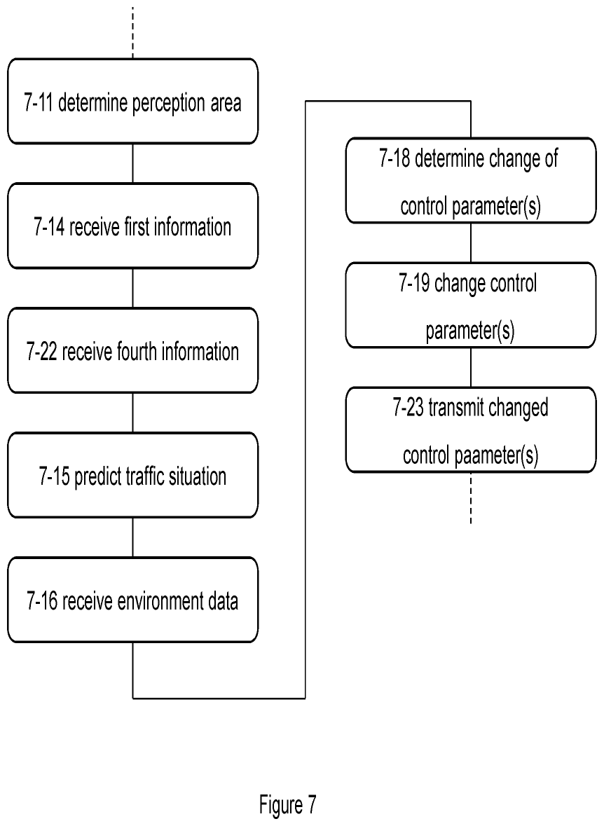

FIGS. 5A and 5B illustrates examples of a time interval period p (5-10) considering communication (D_{com}), processing (D_{proc}) and adaptation (D_{adap}) delay for the distributed approach (FIG. 5A) and the centralized approach (FIG. 5B). For example within the time interval p (5-10) the processes described in the flow diagrams of FIGS. 3 and 4, or the methods at described in FIGS. 6 and 7, will be performed.

The mechanical adaption time D_{adap} may start when the vehicle maneuver decision is either processed by the vehicle (FIG. 5A) or is received from the control system (FIG. 5B) till this decision is executed by the mechanical system of the vehicle at time point T, for example by adapting the acceleration to the decided value.

Global Navigation Satellite System (GNSS) receivers may be used to achieve time synchronization among vehicles. However also other means (for example a synchronization source inside the network) may be used to time synchronise the vehicles.

FIG. 5A shows 2 example embodiments of the decentralized approach, one where clients report their status information at the time point T−p (see upper part of FIG. 5A), and one where clients predict their status information at time point T and transmit their predicted status information to other client (see lower part of FIG. 5A).

Turning now to the upper part of FIG. 5A which shows the decentralized approach from the implementation point of view of client 5-1. Client 5-1 communicates his status information collected at time point T−p (5-7) during period D_{com} (5-11) to other client(s) in its surrounding. In parallel client 5-1 receives the reported status information at time point T−p (5-7) from the client(s) in its surrounding (for example in its perception area). At the end of D_{com} (5-11) client 5-1 has received the status information from its surrounding client(s) and starts to process the received data during D_{proc} (5-12) in order to predict the traffic situation around client 5-1 at time point T (as described for example in connection with FIGS. 1 and 3). After the traffic situation at time point T has been predicted, client 5-1 determines at least one control parameter and a change of the at least one control parameter based on the predicted traffic situation at time point T (this happens still within D_{proc} (5-12)). The determination of the at least one control parameter may take current (local) status information of client 5-1 into account, as well as optionally collected and/or received information about the environment (for example weather data, road condition data, traffic light and traffic sign related data). The determination is done in order to react to changes of the traffic situation predicted for the time point T and/or to react on the current environment status and the current status information from client 5-1 (for example changes may be needed in order to avoid danger situations identified based on the current local information from client 5-1).

After the change of the at least one control parameter has been determined within D_{proc} (5-12), the change of the at least one control parameter will be implemented in client 5-1 either at time point T (5-8), or at time point T−D_{adap} in order to compensate a possible adaptation delay 5-13 in client 5-1, so that client 5-1 starts to physically react on the change at time point T. For example a controller of client 5-1 may adapt its control parameter at time point T−D_{adap}, while the client itself (for example the engine of a vehicle) implements the change at time point T. The adaptation delay D_{adap} may be caused by internal processing delay of the change in client 5-1 and/or mechanical delay to perform the adaption in client 5-1. The adaptation delay D_{adap} (5-13) may be client specific and may be different for different clients or types of clients. A mechanical delay can be for example the time a vehicle takes to reach the desired torque by adjusting the fuel supply in the engine.

After time point T the process starts all over again for the next period p with the next communication phase D_{com}.

The lower part of FIG. 5A shows a different embodiment of the decentralized approach from the implementation point of view of client 5-2. Instead of communicating status information of client 5-2 collected at the time point T−p (like it is described above for the upper part of FIG. 5A), client 5-2 performs first a prediction of its status information (for example its position, speed, acceleration, . . . ) at time point T (5-8) during D_{pred} (5-21), and communicates then the prediction result during D_{com} (5-22) to other client(s) in its surrounding. In parallel client 5-2 receives the reported predicted status information for time point T (5-8) from the clients in its surrounding (for example in its perception area). At the end of D_{com} (5-22) client 5-2 has received the status information from its surrounding clients and starts to process the received data during D_{proc} (5-23) in order to predict the traffic situation around client 5-2 at time point T (as described for example in connection with client 5-1 in the upper part of FIG. 5A). Since client 5-2 already receives the predicted positions of the surrounding clients at time point T, it does not need to perform those predictions by itself during the process of predicting the traffic situation at time point T. This saves processing resources and processing time (and so reduces the delay caused by D_{proc} 5-23) in client 5-2.

The following steps performed by client 5-2 (determination of at least one control parameter to change, changing the at least one control parameter, and implement the change at time point T (5-8) or at time point T−D_{adap} (5-24)) are similar like described for client 5-1 in FIG. 5A above.

Overall predicting the status information of the client 5-2 at time point T (5-8) by itself during D_{pred} (5-21) and transmitting the prediction result to the clients in its surrounding appears to be more efficient, since this predictions needs to be performed only once by client 5-2. In contrast in the embodiment described for client 5-1 in connection with the upper part of FIG. 5A, the prediction of status information of client 5-1 at time point T may be done by multiple clients in parallel, for example by clients receiving the status information of client 5-1 at T−p and using it for predicting a traffic situation at time point T. Thus multiple clients will perform a similar processing (prediction of status information, like for example the position of client 5-1, at time point T) in parallel which appear to be a waste of processing power and resources.

FIG. 5B shows 2 example embodiments of the centralized approach, one where client 5-4 reports its status information at the time point T−p (see upper part of FIG. 5B) to the network entity 5-3, and one where client 5-6 predict its status information at time point T (5-8) and transmit the predicted status information to the network entity 5-5 (see lower part of FIG. 5B).

The upper part of FIG. 5B shows the centralized approach from the implementation point of view of client 5-4. Client 5-4 communicates his status information collected at time point T−p (5-7) during period D_{com1} (5-41, 5.31) to network entity 5-3. In parallel network entity 5-3 may also receive status information from other clients, for example from clients in the surrounding or clients within the perception area of client 5-4. At the end of D_{com1} (5-31) the network entity 5-3 has received the status information from client 5-4 and clients in the surrounding or within the perception area of client 5-3 and starts to process the received data during D_{proc} (5-32) in order to predict the traffic situation around client 5-4 at time point T (as described for example in connection with FIGS. 2 and 4). The processing may take collected and/or received information about the environment (for example weather data, road condition data, traffic light and traffic sign related data) into account. Client 5-4 may wait D_{wait} (5-42), or do something, else during D_{proc} (5-32) of network entity 5-3. After the traffic situation at time point T has been predicted by network entity 5-3, it determines at least one control parameter and a change of the at least one control parameter based on the predicted traffic situation at time point T for client 5-4 (this happens still within D_{proc} (5-32)) in order to instruct (or control) the client to react to changes of the traffic situation predicted for the time point T.

After the change of the at least one control parameter has been determined within D_{proc} (5-32) by network entity 5-3, the change of the at least one control parameter will be communicated to client 5-4 during D_{com1} (5-33, 5.43). After client 5-4 received the information/the instructions to change the at least one control parameter it will implement the change of the at least one control parameter either at time point T (5-8), or at time point T−D_{adap} (5-44) in order to compensate a possible adaptation delay 5-44 in client 5-4, so that client 5-4 starts to physically react on the change at time point T (as described in more detail in connection with FIG. 5A above). After time point T the process starts all over again for the next period p with the next communication phase D_{com1}.

The lower part of FIG. 5B shows a different embodiment of the centralized approach from the implementation point of view of client 5-6. Instead of communicating status information of client 5-6 collected at the time point T−p (like it is described above for the upper part of FIG. 5B), client 5-6 performs a prediction of its status information (for example its position, speed, acceleration, . . . ) at time point T (5-8) during D_{pred} (5-61), and communicates then the prediction result during D_{com} (5-62, 5-52) to network entity 5-5. In parallel network entity 5-5 receives the reported predicted status information for time point T (5-8) from the clients in the surrounding (for example within the perception area) of client 5-6. At the end of D_{com} (5-62, 5-52) network entity 5-5 received the status information from client 5-6 and its surrounding clients and starts to process the received data during D_{proc} (5-53) in order to predict the traffic situation around client 5-6 at time point T (as described for example in connection with client 5-4 in the upper part of FIG. 5B). Since network entity 5-5 already received the predicted positions of the clients at time point T, it does not need to perform those predictions by itself during the process of predicting the traffic situation at time point T. This saves processing resources and processing time (and so reduces the delay caused by D_{proc} 5-53) in network entity 5-5.

The following steps performed by network entity 5-5 and client 5-6 (determination of at least one control parameter to change, changing the at least one control parameter, communicate the change to client 5-6 and implement the change in client 5-6 at time point T (5-8) or at time point T−D_{adap} (5-24)) are similar like described for network entity 5-3 and client 5-4 in FIG. 5B above.

Overall predicting the status information of the client 5-6 at time point T (5-8) by itself during D_{pred} (5-61), and transmitting the prediction result to the network entity 5-5 appears to be more efficient, for example from network entity 5-5 point of view, since network entity 5-5 does not need to perform the prediction of the status information for all clients at time point T which safes processing resources and reduces processing delay during D_{proc} 5-53 in network entity 5-5.

In order to allow mixed scenarios, where some clients may report information related to their status at time point T−p while other clients may report predicted information for the time point T, the clients may transmit together with their information an indication if the information related to time point T−p or is predicted information for the time point T. The client or network entity which receives the information from the client may then extract the indication in order to determine if a prediction for time point T still needs to be done for the client or if the received information already includes the predicted status information of the client so that a prediction can be omitted. An indication if the received information comprises predicted information at time point T or status information at time point T−p may be for example part information 1-6, 1-7 and 1-8 of FIG. 1, of information 2-5, 2-6, 2-7 and 2-8 of FIG. 2, of the first information 3-14 of FIG. 3 or of the first information 4-14 or fourth information 4-22 of FIG. 4. The indication may be also part of the information received in steps 6-14, 7-14 or 7-22 of FIG. 6 or 7.

FIG. 6 shows an example embodiment of a method to control a client for the decentralized approach performed by a second client (for example client 1-2 of FIG. 1, client 3-2 of FIG. 3 or client 5-1/5-2 of FIG. 5A). The steps shown in FIG. 6 are in line with the steps shown in the message flow diagram in FIG. 3. In the following description steps 6-11 to 6-20 may be performed during one time period p between time points T−p and T, wherein step 6-21 may be performed at time point T or shortly after time point T.

In a first optional step 6-11 the second client may determine its perception area. The perception area may be an area around the second client which may have a specific form (for example circle, cube, ellipse, cube) with a specific size. The size and form may be fixed or may vary depending on certain properties, for example the speed or the heading direction of the second client. The perception area may be also defined based on the wireless communication distance the second client can achieve.

In optional step 6-12 the second client may receive a request for third information from at least one first client. The requested third information may be status information of the second client at a time point T−p, or predicted status information of the second client for a time point T in the future.

In optional step 6-13 the second client may transmit a request for first information to the at least one first clients, preferably only to first clients located within the perception area.

The requests in steps 6-12 and 6-13 may indicate which type of information is requested (information at time point T−p or predicted information at time point T).

In step 6-14 the second client receives the first information from the at least one first client. The first information may be received in response to the optional request send in step 6-13, or may be received via a broadcast message transmitted periodically from the at least one first client. The first information comprises status information of the at least one first client, wherein the status information may be status information at time point T−p or predicated status information for the time point T. The first information may comprise an indication if the first information comprises status information at time point T−p or predicted status information at time point T. The status information may be for example at least one of speed, heading direction, position, acceleration, sensor data and a maneuver rule indication of the at least one first client. The sensor data may for example relate to the detected outside temperature, detected wiper activity, detected outside light status or properties of other clients in the vicinity detected by for example a client build in radar.

In step 6-15 the second client performs a prediction of a traffic situation at time point T (preferable limited to the perception area) taking the received first information from the at least one first client into account. The second client may perform the prediction starting from the most distant first client, preferable the most distant first client located in front of the second client.

Once the traffic situation at time point T has been detected, the second client determines in step 6-18 a change of at least one control parameter of the second client based on the predicted traffic situation at time point T, for example to adjust the acceleration or deceleration and/or the driving direction of the second client in order to keep for example a defined distance to a preceding client. The determination of the at least one control parameter may take in addition to the predicted traffic situation at time point T also optionally in step 6-16 received data about the environment (for example traffic sign data, traffic lights data, road conditions, weather conditions) of the second client into account. In addition in step 6-17 detected second information of the second client may be taken into account as well, wherein the second information may comprise actual information of the second client, for example the actual speed or heading of the second client, or the actual outside temperature measured by the second client.

In step 6-19 the second client changes the at least one control parameter based on the determination result, wherein in step 6-20 the change may be implemented by the second client at time point T or at time point T-D_{adap} (to compensate processing and/or mechanical delay caused by the second client).

Finally the second client may transmit in step 6-21 third information to the at least one first client, preferably to the first clients located in the perception area. The third information may be status information of the second client at time point T (after the change of the at least one control parameter has been implemented) or predicted status information for the time point T+p. The third information may be sent in step 6-21 as a response to the request which the second client may have received in step 6-12, or may be sent as broadcast or multicast message to the at least one first client after step 6-20. The third information may comprise an indication if the third information comprises status information at time point T or predicted status information at time point T+p.

The method may then repeat and start all over again for the next period p (T to T+p).

FIG. 7 shows an example embodiment of a method for the centralized approach performed by a (central) network entity (for example network entity 2-10 of FIG. 2, network entity 4-10 of FIG. 4 or network entity 5-3/5-5 of FIG. 5B) to control a second client. The steps shown in FIG. 7 are in line with the steps shown in the message flow diagram in FIG. 4. In the following description steps 7-11 to 7-24 are performed during one time period p between time points T−p and T.

In a first optional step 7-11 the network entity may determine a perception area for a second client. The perception area may be an area around the second client which may have a specific form (for example circle, cube, ellipse, cube) with a specific size. The size and form may be fixed or may vary depending on certain properties, for example the speed or the heading direction of the second client. The perception area may be also defined based on the wireless communication distance the second client can achieve.

In step 7-14 the network entity receives first information from the at least one first client. The first information may be received in response to an optional request send by the network entity to the at least one first client, or may be received via a message transmitted periodically from the at least one first client to the network entity. The optional request may indicate which type of information is requested (information at time point T−p or predicted information at time point T). The first information comprises status information of the at least one first client, wherein the status information may be status information at time point T−p or predicated status information for the time point T. The first information may comprise an indication if the first information comprises status information at time point T−p or predicted status information at time point T. The status information may be for example at least one of speed, heading direction, position, acceleration, sensor data and a maneuver rule indication of the at least one first client. The sensor data may for example relate to the detected outside temperature, detected wiper activity, detected outside light status or properties of other clients in the vicinity detected by for example a client build in radar.

In step 7-22 the network entity receives fourth information from the second client. The fourth information may be received in response to an optional request send by the network entity to the second client, or may be received via a message transmitted periodically from the second client to the network entity. The optional request may indicate which type of information is requested (information at time point T−p or predicted information at time point T). The fourth information comprises status information of the at second client wherein the information is comparable to the first information described above.

In step 7-15 the network entity performs a prediction of a traffic situation at time point T for the second client, taking the received first information and fourth information into account. The predicated traffic situation at time point T may be limited by to the perception are of the second client. The network entity may perform the prediction starting from the first client most distant from the second client, preferable the most distant first client located in front of the second client.

Once the traffic situation at time point T has been predicted, the network entity determines in step 7-18 a change of at least one control parameter of the second client based on the predicted traffic situation at time point T, for example to adjust the acceleration or deceleration and/or the driving direction of the second client in order to keep for example a defined distance to a preceding client. The determination of the at least one control parameter may take in addition to the predicted traffic situation at time point T also the optionally in step 7-16 received data about the environment (for example traffic sign data, traffic lights data, road conditions, weather conditions) related to the second client into account.

In step 7-19 the network entity changes the at least one control parameter based on the determination result and transmits in step 7-23 the changed at least one control parameter to the second client prior to time point T.

The method may then repeat and start all over again for the next period p (T to T+p).

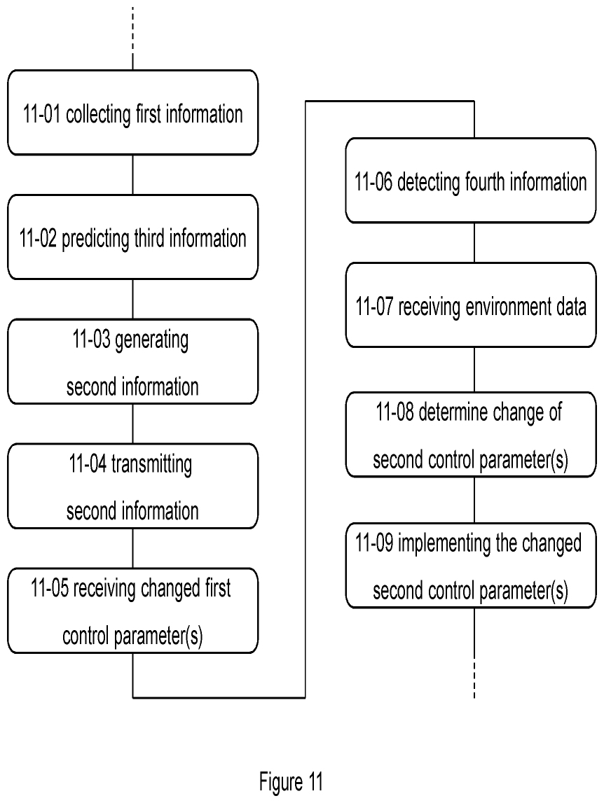

FIG. 11 shows an example embodiment of a method for the centralized approach performed by a client (for example second client 2-2 of FIG. 2, second client 4-2 of FIG. 4 or client 5-4 or 5-6 of FIG. 5B). The steps shown in FIG. 11 are in line with the steps shown in the message flow diagram in FIG. 4 for the second client 4-2. In the following description steps 11-01 to 11-08 may be performed during one time period p between time points T−p and T, wherein step 11-09 may be performed at time point T or shortly after time point T.

In step 11-01 the client collects first information. The first information relates to status information at time point T−p of the client which may be collected via sensors and may be speed, heading direction, acceleration, selected maneuver rule or the position of the client.

Optionally the client may predict in step 11-02 third information, wherein the third information may be predicted status information of the client at time point T. The prediction may be based on the first information.

In step 11-03 the client generates second information based on one of the first information, the second information predicted for time point T, or a combination of both. The second information allows to determine a position of the client at the time point T and may comprise the predicted position of the client at time point T.

In step 11-04 the client transmits the second information, for example to a network entity performing a central control function which may control the client (for example network entity 4-10 of FIG. 4).

In step 11-05 the client receives at least one changed first control parameter from the control entity. The at least one changed first control parameter may be a control parameter for the client which has been determined by the network entity (for example a central control function) based on a predicted traffic situation, wherein the predicted traffic situation may be determined at the network entity by taking the second information into account.

In optional step 11-06 the client may detect fourth information. The fourth information may be actual information of the client, like for example actual speed, heading direction, acceleration, selected maneuver rule or the actual position of the client.

In optional step 11-07 the client may receive environment data, which may be information from traffic lights, traffic signs or weather data.

Then the client determines in step 11-08 a change of at least one second control parameter based on the at least one changed first control parameter received in step 11-05. The change of the at least one second control parameter may be similar to the change of the at least one first control parameter, or may be a modification change of the at least one first control parameter taking the fourth information and/or the environment data into account to prevent for example danger situations which may occur due to changes of the client status or its surrounding after sending the second information in step 11-04.

Finally the client is implementing the changed at least one second control parameter in step 11-09. As described more in detail in connection with FIG. 5B, the implementation may be done at time point T or before time point T to compensate a possible adaptation delay.

After the implementation of the changed at least one second control parameter in the client in step 11-09 the process may start all over again.

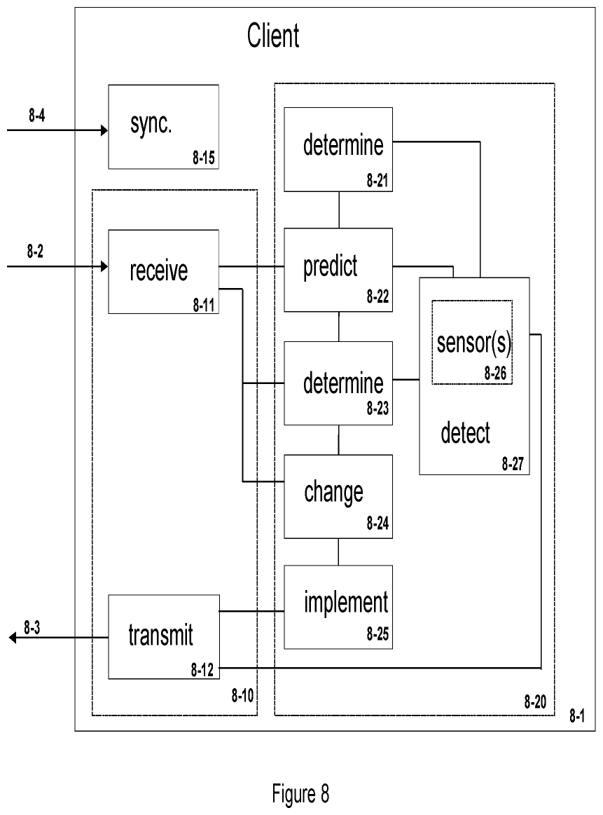

FIG. 8 shows an example embodiment of a client 8-1 adapted to perform a method as shown in FIG. 6. The client may be for example second client 1-2 as shown in FIG. 1, second client 3-2 as shown in FIG. 3 or client 5-1/5-2 as shown in FIG. 5A.

The client 8-1 may comprise a synchronisation module 8-15, which may receive a synchronisation signal 8-4 from a network element (for example a synchronization source) or via a GPS signal. The synchronisation signal may be used to synchronize the steps and actions which re performed by the second client with steps or actions performed by other clients and/or network elements (for example the central controller/network entity in the centralized architecture as described with respect to FIGS. 2, 4, 5B and 7).

The second client 8-1 further comprises a receiver module 8-11, which receives first information 8-2 as shown in FIG. 3 step 3-14 or FIG. 6 step 6-14. The receiver module 8-11 may further receive a request for third information as shown in FIG. 3 step 3-12 or FIG. 6 step 6-12, or environment data as shown in FIG. 3 step 3-16 or FIG. 6 step 6-16.

Further the second client 8-1 comprises a transmitter module 8-12, which may transmit information 8-3, for example a request for first information as shown in FIG. 3 step 3-13 or FIG. 6 step 6-13, or third information as shown in FIG. 3 step 3-21 or FIG. 6 step 6-21.

The receiver module 8-11 and the transmitter module 8-12 of the second client 8-1 may be combined in a transceiver module 8-10.

Further the second client 8-1 may comprise a determination module 8-21 for determining a perception area of the second client. The determination may be performed as described in conjunction with FIG. 1, FIG. 3 step 3-11 or FIG. 6 step 6-11.

The second client 8-1 comprises a prediction module 8-22 for predicting a traffic situation at time point T. The prediction may be performed as described in conjunction with FIG. 1, FIG. 3 step 3-15 or FIG. 6 step 6-15.

Further the second client 8-1 may comprise a detection module 8-27 for detecting second information from the second client, wherein the second information may comprise actual information of the second client. The detection may be performed as described in conjunction with FIG. 1, FIG. 3 step 3-17 or FIG. 6 step 6-17. The detection may utilize local sensor(s) 8-26 for detecting the second information.

Still further the second client 8-1 comprises a determination module 8-23 for determining a change of at least one control parameter of the second client based on the predicted traffic situation at the time point T. The determination may be performed as described in conjunction with FIG. 1, FIG. 3 step 3-18 or FIG. 6 step 6-18 and may use in addition the second information and the environment data for the determination.

The second client 8-1 further comprises a changing module 8-24 for changing the at least one control parameter of the second client based on the determination result of module 8-23. The changing may be performed as described in conjunction with FIG. 1, FIG. 3 step 3-19 or FIG. 6 step 6-19.

Still further the second client 8-1 may comprise an implementation module 8-25 for implementing the change of the at least one control parameter at time point T or time point T−D_{adap}. The implementation may be performed as described in conjunction with FIG. 1, FIG. 3 step 3-20 or FIG. 6 step 6-20.

Finally modules 8-21, 8-22, 8-23, 8-24, 8-25 and 8-27 may be implemented (8-20) in HW, in SW executed by one or more processors, or in a combination of both.

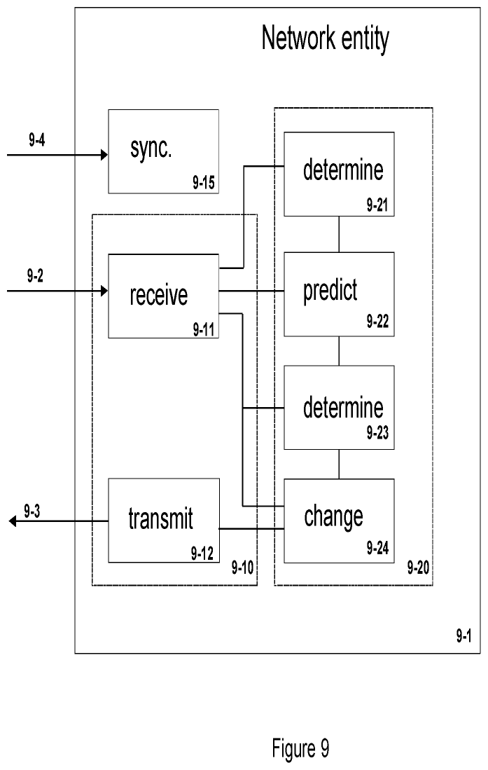

FIG. 9 shows an example embodiment of a network entity 9-1 adapted to perform a method as shown in FIG. 7. The network entity may be for example network entity 2-10 as shown in FIG. 2, network entity 4-10 as shown in FIG. 4 or network entity 5-3/5-5 as shown in FIG. 5B.

The network entity 9-1 may comprise a synchronisation module 9-15, which may receive a synchronisation signal 9-4 from a network element (for example a synchronization source) or via a GPS signal. The synchronisation signal may be used to synchronize the steps and actions which are performed by the network entity with steps or actions performed by clients (for example clients 2-1, 2-2, 2-3 and 2-4 of FIG. 2 in a centralized architecture as described with respect to FIGS. 2, 4, 5B and 7).

The network entity 9-1 further comprises a receiver module 9-11, which receives first information 9-2 as shown in FIG. 4 step 4-14 or FIG. 7 step 7-14. The receiver module 9-11 may further receive fourth information as shown in FIG. 4 step 4-22 or FIG. 7 step 7-22, or environment data as shown in FIG. 4 step 4-16 or FIG. 7 step 7-16.

Further the network entity 9-1 comprises a transmitter module 9-12, which may transmit information 9-3, for example transmit a changed at least one control parameter to the second client as shown in FIG. 4 step 4-23 or FIG. 7 step 7-23.

The receiver module 9-11 and the transmitter module 9-12 of the network entity 9-1 may be combined in a transceiver module 9-10.

Further the network entity 9-1 may comprise a determination module 9-21 for determining a perception area for the second client. The determination may be performed as described in conjunction with FIG. 2, FIG. 4 step 4-11 or FIG. 7 step 7-11.

The network entity 9-1 comprises a prediction module 9-22 for predicting a traffic situation at time point T for the second client. The prediction may be performed as described in conjunction with FIG. 2, FIG. 4 step 4-15 or FIG. 7 step 7-15.

Still further the network entity 9-1 comprises a determination module 9-23 for determining a change of at least one control parameter of the second client based on the predicted traffic situation at the time point T. The determination may be performed as described in conjunction with FIG. 2, FIG. 4 step 4-18 or FIG. 7 step 7-18 and may use the environment data for the determination.

The network entity 9-1 further comprises a changing module 9-24 for changing the at least one control parameter of the second client based on the determination result of module 9-23. The changing may be performed as described in conjunction with FIG. 2, FIG. 4 step 4-19 or FIG. 7 step 7-19.

Finally modules 9-21, 9-22, 9-23 and 9-24 may be implemented (9-20) in HW, in SW executed by one or more processors, or in a combination of both.

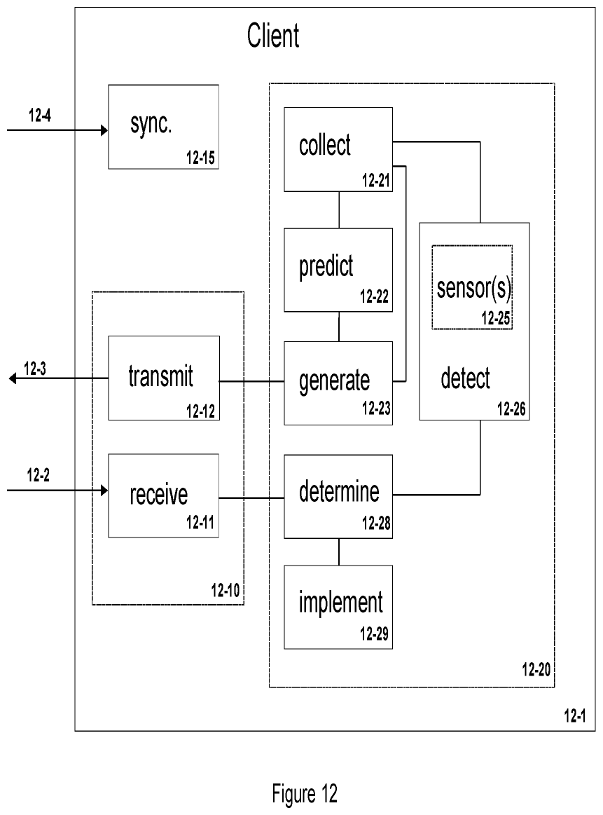

FIG. 12 shows an example embodiment of a client 12-1 adapted to perform a method as shown in FIG. 11. The client may be for example the second client 2-2 as shown in FIG. 2, the second client 4-2 as shown in FIG. 4 or client 5-4/5-6 as shown in FIG. 5B.

The client 12-1 may comprise a synchronisation module 12-15, which may receive a synchronisation signal 12-4 from a network element (for example a synchronization source) or via a GPS signal. The synchronisation signal may be used to synchronize the steps and actions which are performed by the client with steps or actions performed by other clients (for example clients 2-1, 2-2, 2-3 and 2-4 of FIG. 2 in a centralized architecture as described with respect to FIGS. 2, 4, 5B, 7 and 11) or a central network entity controlling the client.

The client 12-1 further comprises a receiver module 12-11, which is configured to receive information 12-2, for example the at least one changed control parameter as shown in FIG. 4 step 4-23 or FIG. 11 step 11-05. The receiver module 12-11 may further be configured to receive environment data as shown in FIG. 4 step 4-25 or FIG. 11 step 11-07.

Further the client 12-1 comprises a transmitter module 12-12, which is configured to transmit information 12-3, for example transmit fourth information as shown in FIG. 4 step 4-22 or second information as shown in FIG. 11 step 11-04.

The receiver module 12-11 and the transmitter module 12-12 of the client 12-1 may be combined in a transceiver module 12-10.

Further the client 12-1 may comprise a detect module 12-26 for detecting status information of the client, wherein the status information may be for example information reflecting actual status information of the client. The detection may be done by using sensors 12-25, and the detected information may be used as input by other modules of the client 12-1, for example collect module 12-21 or determine module 12-28. The detected information may be the information as described in conjunction with FIG. 4 step 4-17 or FIG. 11 step 11-06.

Client 12-1 further comprises a collect module 12-21 for collecting information about the client at time point T−p. The information may be the information as described in conjunction with FIG. 4 step 4-25 or FIG. 11 step 11-01.

Client 12-1 may further comprise a predict module 2-22 for predicting information about the client at time point T. The predicted information may be the information as described in conjunction with FIG. 4 step 4-26 or FIG. 11 step 11-02.

Further the client 12-1 comprises a generate module 12-23 for generating second information based on the first information. The generated second information may be the information as described in conjunction with FIG. 4 step 4-27 or FIG. 11 step 11-03. The second information allows to determine a position of the client 12-11 at the time point T

Client 12-1 further comprises a determine module 12-28 for determining a change of at least one second control parameter based on a received at least one first control parameter. The determined change of the at least one second control parameter may be the change determined in conjunction with FIG. 4 step 4-28 or FIG. 11 step 11-08.

Still further client 12-1 comprises an implementation module 12-29 for implementing the change of the at least one second control parameter at time point T or time point T−D_{adap}. The implementation may be performed as described in conjunction with FIG. 2, FIG. 4 step 4-24 or FIG. 11 step 11-09.

Finally modules 12-21, 12-22, 12-23, 12-26, 12-28 and 12-29 may be implemented (12-20) in HW, in SW executed by one or more processors, or in a combination of both.

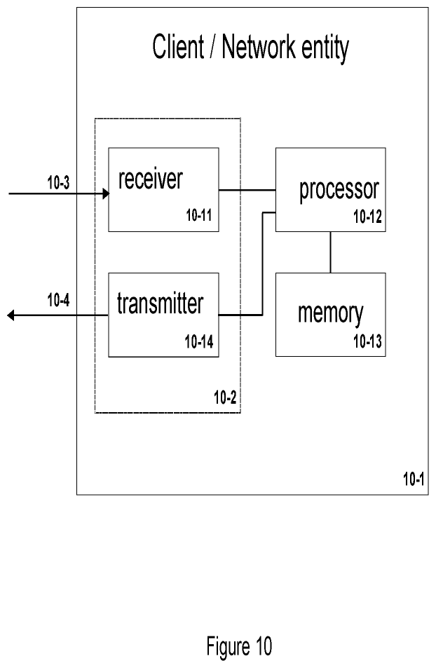

FIG. 10 is an example block diagram illustrating embodiments of client 8-1 or client 12-1 (for example a vehicle) or network entity 9.1 (for example central controller). The client 8-1 or 12-1 may be for example a mobile device (like a mobile phone, a smart phone, a PDA (Personal Digital Assistant) or a portable computer (e.g., laptop, tablet)); a vehicle (like for example a car, a truck, a bike, a plane, a ship or a sub-marine), a machine-to-machine device (like for example a sensor) or any other device that can provide wireless communication). A client may also be referred to as a radio node, user equipment (UE), or an on-board unit (or module) in a further device, like for example a car or a vehicle which may move on the ground, airborne or underwater. Examples of a network entity may be a server, a base station, a road side cabinet, a controller or an access point.

The client/network entity may comprise an interface 10-2, a processor 10-12 and a memory 10-13. The interface 10-2 may further comprise a receiver 10-11 and a transmitter 10-14. The receiver 10-11 and the transmitter 10-14 may be combined in a transceiver. The receiver may receive signals 10-3 and the transmitter may transmit signals 10-4 from and to the element 10-1. Signals may be transmitted wirelessly (e.g., via an antenna which is not shown). Processor 10-12 may execute instructions to provide some or all of the functionality described above as being provided by the network entity or the client. Memory 10-13 may store instructions executed by processor 10-12, for example instructions to perform a method as described in FIGS. 6 (for the client) or 7 (for the network entity) or 11 (for the client).

Processor 10-12 may comprise any suitable combination of hardware and software implemented in one or more modules to execute instructions and manipulate information/data to perform some or all of the described functions of 10-1 (for example the client or the network entity). In some embodiments, processor 10-12 may comprise one or more computers, one or more central processing units (CPUs), one or more microprocessors, one or more applications, and/or other logic.

Memory 10-13 may be generally operable to store instructions, such as a computer program, software, an application comprising one or more of logic, rules, algorithms, code, tables, etc. and/or other instructions capable of being executed by a processor. Examples of memory 10-13 may comprise computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

Alternative embodiments of the client 8-1 or 12-1 and the network entity 9-1 may comprise additional components beyond those shown in FIGS. 8 to 10 and 12. Those additional components may provide certain aspects of the functionality, including any of the functionality described herein and/or any additional functionality (including any functionality necessary to support the solution described herein).

Various different types of elements may comprise components having the same physical hardware but may be configured (e.g., via programming) to support different radio access technologies, or may represent partly or entirely different physical components.

Considering a traffic scenario where there is a mixture of different types of vehicles (for example human-driven vehicles, ACC controlled vehicles, CACC controlled vehicles) vehicles using the described centralized or distributed control method may adjust their operation parameters to coexist with the others. For example, if the front vehicle is a human driven or (C)ACC controlled vehicle and is not equipped with a vehicle-to-vehicle or vehicle to infrastructure communication device, then the driving environment of the front vehicle cannot be known to neighbouring vehicles and its maneuver decision cannot be predicted. In this case the following vehicle using the described control method may need an enlarged inter-vehicle time gap to guarantee system stability, for example effectively falling back to the traditional ACC.

When the neighbouring vehicles (including the vehicle driving at the front) are all autonomous vehicles with vehicle-to-vehicle or vehicle to infrastructure communication devices supporting the described control method, then the maneuver of the front vehicle can be predicted and the desired distance between them can be reduced. That is, depending on the type of its preceding vehicle, a vehicle using the described control method may run with adjusted parameters accordingly, thus the overall traffic throughput would increase in a mixed scenario of vehicles supporting the described control method and legacy vehicles not supporting it. The higher the amount of vehicles supporting the described control method is, the more the overall throughput will be increases. Thus the described control method provides also advantages in view of traffic throughput and fuel consumption in a mixed scenario. In addition safety is increased due to the reduced/optimized reaction time of vehicles supporting the proposed control method.

The described vehicle control method provides superior performance than conventional ACC and C-ACC, as far as multiple autonomous vehicles drive next to each other. This also means that in hybrid traffic situation, where both autonomous and non-autonomous vehicles are present, the proposed control method will be also beneficial, although the advantage is maximized in a homogenous autonomous vehicle environment.

Some embodiments of the disclosure may provide one or more technical advantages. Some embodiments may benefit from some, none, or all of these advantages. Other technical advantages may be readily ascertained by one of ordinary skill in the art.

In a first aspect an example embodiment of a method for controlling a client is provided. The method comprising receiving first information of at least one first client, wherein the first information allows to determine a position of the at least one first client at a time point T. The method further comprising predicting a traffic situation at the time point T using the first information; determining a change of at least one control parameter of a second client based on the predicted traffic situation at the time point T; and changing the at least one control parameter of the second client based on the determination result.

Refinements of the method according to the first aspect may comprise one or more of:
wherein the method may be repeated with a period p;
wherein the controlling of the client may be synchronized to a common time base;
wherein the first information may comprise at least one of sensor information, status information and control information of the at least one first client at time point T−p or predicted for time point T;
wherein the first information may comprise at least one of
   speed;
   heading direction;
   position;
   acceleration;
   deceleration;
   sensor data; and
   a maneuver rule indication;
of the at least one first client at time point T−p or predicted for the time point T;
wherein the at least one control parameter of the second client may comprise at least one of
   speed;
   acceleration;
   deceleration;
   heading direction and
   a selected maneuver rule;
determining a perception area for the second client where information received from clients located in the perception area may be used to predict the traffic situation at time point T, wherein the at least one first client may be located in the perception area;
wherein the prediction of the traffic situation at time point T may comprise performing a prediction for each of the at least one first client separately starting from the most distant client within the perception area;
receiving data about the environment; wherein the determining of the change of the at least one control parameter of the second client may further comprise using the data about the environment for the determination;
wherein the data may comprise at least one of
   traffic sign data;
   traffic lights data;
   road condition data; and
   weather data;
wherein the method may be performed in the second client;
detecting second information; wherein the second information may comprise actual information of the second client; and wherein the determining of the change of the at least one control parameter of the second client may further comprise using the second information for the determination;
implementing the changing of the at least one control parameter at the second client at time point T;
implementing the changing of the at least one control parameter at the second client at time point T minus an adaptation delay D_{adap};
transmitting third information about the second client to the at least one first client, wherein the third information may allow to predict the position of the second client at time point T+p;
wherein the at least one first client and the second client may be time synchronized to the common time base;
receiving fourth information of the second client which allows to predict the position of the second client at time point T; transmitting the changed at least one control parameter to the second client; wherein the fourth information may be used when predicting the traffic situation at the time point T and wherein the method may be performed at a network entity; and
wherein the at least one first client or the second client may comprise one of a vehicle, a mobile device, a mobile device inside a vehicle, a module or a module installed inside a vehicle.

In a second aspect an example embodiment of an apparatus for controlling a client is provided. The apparatus comprising a first module configured to receive first information of at least one first client, wherein the first information allows to determine a position of the at least one first client at a time point T (5-8). The apparatus further comprising a second module configured to predict a traffic situation at the time point T using the first information; a third module configured to determine a change of at least one control parameter of a second client based on the predicted traffic situation at the time point T; and a fourth module configured to change the at least one control parameter of the second client based on the determination result.

In a third aspect an example embodiment of an apparatus for controlling a client is provided. The apparatus comprising at least one processor, the at least one processor is configured to receive first information of at least one first client, wherein the first information allows to determine a position of the at least one first client at a time point T. The at least one processor is further configured to predict a traffic situation at the time point T using the first information; to determine a change of at least one control parameter of a second client based on the predicted traffic situation at the time point T; and to change the at least one control parameter of the second client based on the determination result.

Refinements of the apparatus according to the second or the third aspect may comprise one or more of:
wherein the controlling of the client may happen periodically with a period p;
wherein the controlling of the client may be synchronized to a common time base;
wherein the first information may comprise at least one of sensor information, status information and control information of the at least one first client at time point T−p or predicted for time point;
wherein the first information may comprise at least one of
   speed;
   heading direction; and
   position;
   acceleration;
   deceleration;
   sensor data; and
   a maneuver rules indication;
of the at least one first client at time point T−p or predicted for the time point T.
wherein the at least one control parameter of the second client may comprise at least one of
   speed;
   acceleration;
   deceleration;
   heading direction and
   a selected maneuver rule;
a fifth module configured to determine a perception area for the second client where information received from clients located in the perception area is used to predict the traffic situation at time point T; wherein the at least one first client may be located in the perception area;
wherein the prediction of the traffic situation at time point T may comprise performing a prediction for each of the at least one first client separately starting from the most distant client within the perception area;
wherein the first module may be further configured to receive data about the environment, and wherein the third module may be further configured to use the data about the environment for the determination;
wherein the data may comprise at least one of
   traffic sign data;
   traffic lights data;
   road condition data; and
   weather data;
wherein the second client may comprise the apparatus;
a sixth module configured to detect second information; wherein the second information may comprise actual information of the second client; and wherein the third module may be further configured to use the second information for the determination;
a seventh module configured to implement the change of the at least one control parameter at time point Tor at time point T minus an adaptation delay D_{adap};
an eighth module configured to transmit third information about the second client to the at least one first client, wherein the third information may allow to predict the position of the second client at time point T+p;
wherein the at least one first client and the second client may be time synchronized to the common time base;
a ninth module configured to transmit the changed at least one control parameter to the second client; wherein the first module may be further configured to receive fourth information of the second client which allows to predict the position of the second client at time point T; wherein the fourth information may be used when predicting the traffic situation at the time point T; and wherein a network entity may comprise the apparatus;
wherein the at least one first client or the second client may comprise any of a vehicle, a mobile device, a mobile device inside a vehicle, a module or a module installed inside a vehicle.

In a fourth aspect an example embodiment of a computer program is provided. The computer program comprising program code to be executed by at least one processor of an apparatus wherein the execution of the program code causes the at least one processor to execute a method according to the first aspect.

Refinements of the computer program according to the fourth aspect may be according to the one or more refinements of the method according to the first aspect or one or more of:
the computer program may be a computer program product;
the computer program may comprise a non-transitory computer readable storage medium storing the program code.

In a fifth aspect an example embodiment of a method for controlling a client is provided. The method comprising collecting first information of the client at time point T−p; generating second information based on the first information, wherein the first or the second information allows to determine a position of the client at time point T; transmitting the second information to a controlling entity; receiving at least one changed first control parameter from the controlling entity; determining a change of at least one second control parameter based on the changed at least one first control parameter; and implementing the changed at least one second control parameter at the client at a time point T or at a time point T minus an adaptation delay D_{adap}.

Refinements of the method according to the fifth aspect may comprise one or more of:
wherein the second information may comprise at least partly the first information;
predicting third information of the client at time point T based on the first information; wherein the third information may allow to determine a position of the client at the time point T and wherein the second information may comprise at least partly the third information;
wherein the second information may comprise an indication allowing to identify the time point where the second information relates to;
detecting fourth information; wherein the fourth information may comprise actual information of the client; and wherein the determining of the change of the at least one second control parameter may further comprise using the fourth information for the determination;
receiving data about the environment; wherein the determining of the change of the at least one second control parameter may further comprise using the data about the environment for the determination.

In a sixth aspect an example embodiment of a client is provided. The client comprising a first module configured to collect first information of the client at time point T−p; a second module configured to generate second information based on the first information, wherein the first or the second information allows to determine a position of the client at time point T; a third module configured to transmit the second information to a controlling entity; a fourth module configured to receive at least one changed first control parameter from the controlling entity; a fifth module configured to determine a change of at least one second control parameter based on the changed at least one first control parameter; and a sixth module configured to implement the changed at least one second control parameter at the client at a time point T or at a time point T minus an adaptation delay D_{adap}.

In a seventh aspect an example embodiment of a client is provided. The client comprising at least one processor, the at least one processor is configured to collect first information of the client at time point T−p; to generate second information based on the first information, wherein the first or the second information allows to determine a position of the client at time point T; to transmit the second information to a controlling entity; to receive at least one changed first control parameter from the controlling entity; to determine a change of at least one second control parameter based on the changed at least one first control parameter; and zo implement the changed at least one second control parameter at the client at a time point T or at a time point T minus an adaptation delay D_{adap}.

Refinements of a client according to the sixth or seventh aspect may comprise one or more of:
wherein the second information may comprise at least partly the first information;
a seventh module configured to predict third information of the client at time point T based on the first information; wherein the third information may allow to determine a position of the client at the time point T; wherein the second information may comprise at least partly the third information;
wherein the second information may comprise an indication allowing to identify the time point where the second information relates to;
an eighth module configured to detect fourth information; wherein the fourth information may comprise actual information of the client; and wherein the fifth module may further be configured to determine the change of the at least one second control parameter using the fourth information;
wherein the fourth module may further be configured to receive data about the environment; wherein the fifth module may further be configured to determine the change of the at least one second control parameter using the data about the environment.

In an eighth aspect an example embodiment of a computer program is provided. The computer program comprising program code to be executed by at least one processor of an apparatus wherein the execution of the program code causes the at least one processor to execute a method according to the fifth aspect.

Refinements of the computer program according to the eighth aspect may be according to the one or more refinements of the method according to the fifth aspect or one or more of:
the computer program may be a computer program product;
the computer program may comprise a non-transitory computer readable storage medium storing the program code.

In a ninth aspect of an example embodiment a system for controlling a client is provided. The system comprising at least one first client and an apparatus according to the second or third aspect.

Refinements of the system according to the ninth aspect may be according to the one or more refinements of the apparatus according to the second or third aspect.

In a tenth aspect of an example embodiment a system for controlling a client is provided. The system comprising a client according to sixth or seventh aspect and an apparatus according to second or third aspect.

Refinements of the system according to the tenth aspect may be according to the one or more refinements of the client according to the sixth or seventh aspect or the apparatus according to the second or third aspect.

It is to be understood that the examples and embodiments as explained above are merely illustrative and susceptible to various modifications. For example, the concepts could be used in other types of communication networks, not explicitly mentioned so far. Further, it is to be understood that the above concepts may be implemented by using correspondingly designed software in existing nodes, or by using dedicated hardware in the respective nodes.

Abbreviations:
5G 5^{th} Generation (5^{th} Generation Mobile Network)
ACC Adaptive Cruise Control
ADAS Advanced Driver Assistance System
CACC Cooperative Adaptive Cruise Control
CD Compact Disk
CPU Central Processing Unit
DVD Digital Video Disk
CPU Central Processing Unit
GNSS Global Navigation Satellite System
GSM Global System for Mobile Communications
GPS Global Positioning System
HW Hardware
LTE Long Term Evolution
PDA Personal Digital Assistant
RAM Random Access Memory
ROM Read Only Memory
SW Software
UE User Equipment
UMTS Universal Mobile Telecommunications System
V2V Vehicle-to-Vehicle
V2X Vehicle to anything (covers for example vehicle to infrastructure, V2V, vehicle to pedestrian, . . . )
WiFi any kind of WLAN network, synonym to WLAN
WLAN Wireless Local Area Network
   This listing of claims will replace all prior versions, and listings, of claims in the application:

1. A method for controlling a client, the method comprising:
receiving first information of at least one first client, wherein the first information allows to determine a position of the at least one first client at a time point T;
predicting a traffic situation at the time point T using the first information;
determining a change of at least one control parameter of a second client based on the predicted traffic situation at the time point T; and
changing the at least one control parameter of the second client based on the determination result.

2. The method of claim 1, wherein the method is repeated with a period p.

3. The method of claim 1, wherein the controlling of the client is synchronized to a common time base, and wherein the at least one first client and the second client are time synchronized to the common time base.

4. The method of claim 1, wherein the first information comprises at least one of sensor information, status information and control information of the at least one first client at time point T−p or predicted for time point T.

5.-8. (canceled)

9. The method of claim 1, the method further comprising
receiving data about the environment;
wherein the determining of the change of the at least one control parameter of the second client further comprises using the data about the environment for the determination.

10.-13. (canceled)

14. The method of claim 1, the method further comprising
implementing (6-20) the changing of the at least one control parameter at the second client at time point T minus an adaptation delay D_{adap} (5-13, 5-24, 5-44. 5-65).

15.-18. (canceled)

19. An apparatus for controlling a client comprising:
a processor; and
memory coupled with the processor ,wherein the memory is operable to store instructions capable of being executed by the processor so that the processor is operable to,
receive first information of at least one first client, wherein the first information allows to determine a position of the at least one first client at a time point T,
predict a traffic situation at the time point T using the first information,
determine a change of at least one control parameter of a second client based on the predicted traffic situation at the time point T, and
change the at least one control parameter of the second client based on the determination result.

20. The apparatus of claim 19, wherein the controlling of the client happens periodically with a period p.

21. The apparatus of claim 19, wherein the controlling of the client is synchronized to a common time base, and wherein the at least one first client and the second client are time synchronized to the common time base.

22.-28. (canceled)

29. The apparatus of claim 19, wherein the second client comprises the apparatus.

30.-34. (canceled)

35. The apparatus of claim 19, wherein the memory is further operable to store instructions capable of being executed by the processor so that the processor is operable to,
transmit the changed at least one control parameter to the second client;
receive fourth information of the second client which allows to predict the position of the second client at time point T;
wherein the fourth information is used when predicting the traffic situation at the time point T; and
wherein a network entity comprises the apparatus.

36. (canceled)

37. A method for controlling a client, the method comprising:
collecting first information of the client at time point T−p;
generating second information based on the first information, wherein the second information allows to determine a position of the client at time point;
transmitting the second information to a controlling entity;
receiving at least one changed first control parameter from the controlling entity;
determining a change of at least one second control parameter based on the changed at least one first control parameter; and
implementing the changed at least one second control parameter at the client at a time point T or at a time point T minus an adaptation delay D_{adap}.

38. (canceled)

39. The method of claim 37, the method further comprising
predicting (11-02) third information of the client at time point T based on the first information;
wherein the third information allows to determine a position of the client at the time point T; and wherein the second information comprises at least partly the third information.

40. The method of claim 37, wherein the second information comprises an indication allowing to identify the time point where the second information relates to.

41. (canceled)

42. The method of claim 37, the method further comprising
receiving data about the environment;
wherein the determining of the change of the at least one second control parameter further comprises using the data about the environment for the determination.

43. A client comprising:
a processor; and
memory coupled with the processor ,wherein the memory is operable to store instructions capable of being executed by the processor so that the processor is operable to,
collect first information of the client at time point T,31 p;
generate second information based on the first information, wherein the second information allows to determine a position of the client at time point T,
transmit the second information to a controlling entity,
receive at least one changed first control parameter from the controlling entity,
determine a change of at least one second control parameter based on the changed at least one first control parmameter, and
implement the changed at least one second control parameter at the client at a time point T or at a time point T minus an adaptation delay D_{adap}.

44. (canceled)

45. The client of claim 43, wherein the memory is further operable to store instructions capable of being executed by the processor so that the processor is operable to,
predict third information of the client at time point T based on the first information;
wherein the third information allows to determine a position of the client at the time point T; and wherein the second information comprises at least partly the third information.

46.-47. (canceled)

48. The client of claim 43, wherein the memory is further operable to store instructions capable of being executed by the processor so that the processor is operable to,
receive data about the environment;
wherein determining a change of at least one second control parameter comprises determining the change of the at least one second control parameter using the data about the environment.

49. A computer program product comprising a non-transitory computer-readable medium having computer-readable program code to be executed by at least one processor of an apparatus wherein the execution of the program code causes the at least one processor to execute a method according to claim 1.

50.-51. (canceled)

52. A computer program product comprising a non-transitory computer-readable medium having computer-readable program code to be executed by at least one processor of an apparatus wherein the execution of the program code causes the at least one processor to execute a method according to claim 19.
